(19) United States
(12) Patent Application Publication
(10) Pub. No.: US 2008/0174631 A1
(43) Pub. Date: Jul. 24, 2008

(54) IMAGE FORMING APPARATUS HAVING A PLURALITY OF LIQUID DISCHARGE HEADS

(76) Inventor: Hisashi HABASHI, Isehara-shi (JP)

Correspondence Address: COOPER & DUNHAM, LLP, 1185 AVENUE OF THE AMERICAS, NEW YORK, NY, 10036, US

(21) Appl. No.: 12/019,489

(22) Filed: Jan. 24, 2008

(30) Foreign Application Priority Data
Jan. 24, 2007 (JP) 2007-014185

(51) Int. Cl. B41J 2/165

(52) U.S. Cl. 347/30

(57) ABSTRACT

An image forming apparatus includes a head unit, a cap unit, a suction device, a wiper unit, and a control unit. The head unit includes a plurality of liquid discharge heads, each having a nozzle face on which a plurality of nozzles are formed. The cap unit caps the nozzle faces of the liquid discharge heads. The suction device suctions an inside of the cap unit while the nozzle faces are capped with the cap unit. The wiper unit wipes the nozzle faces in a manner that a portion of one nozzle face is wiped after a portion of another nozzle face is wiped. The control unit controls a maintenance operation of the liquid discharge heads by selecting a first ejection operation to eject a first amount of liquid and a second ejection operation to eject a second amount of liquid, which is less than the first amount.

### TECHNICAL FIELD

The following disclosure relates generally to image forming apparatuses, and more specifically, an image forming apparatus having a plurality of liquid discharge heads.

### DESCRIPTION OF RELATED ART

An image forming apparatus used as a printer, facsimile machine, copier, or multi-functional device may have a liquid discharge device including a recording head configured as, for example, a liquid discharge head for discharging droplets of a recording liquid (for example, ink). Such image forming apparatuses discharge droplets from nozzles of the liquid discharge head to form a desired image on a recording medium (hereinafter “sheet” or “sheets”).

When liquid droplets are discharged from nozzles of such a liquid discharge head, residual liquid, dust, or other foreign matter may adhere on a nozzle formation face of the liquid discharge head, resulting in clogging of the nozzles. Alternatively, air bubbles generated in the nozzles may result in discharge failures. Hence, such image forming apparatuses typically have a maintenance-and-recovery mechanism to facilitate normal liquid discharge operation.

For example, one conventional maintenance-and-recovery mechanism has a cap member to cover and seal a nozzle face of a liquid discharge head, or a suction device (for example, a suction pump) communicating with the cap member to suction ink or other liquid stored in the liquid discharge head. Such a maintenance-and-recovery mechanism may also have a wiping member, for example, a wiper blade made of rubber or other elastic material to wipe the nozzle face. Such suctioning and wiping operations may be performed with a preliminary discharge operation to discharge ink from the nozzles for maintenance. Thus, air bubbles in liquid chambers of the liquid discharge head, or residual ink and dust adhered to the nozzle face may be removed, thereby maintaining the nozzles in a state suitable for stable droplet discharge operation.

Recently, for such image forming apparatuses, various line-type recording heads (hereinafter “head unit” or “head units”) have been developed to enhance printing speed. For example, one conventional head unit includes a plurality of liquid discharge heads (also called “head chips”, “nozzle blocks”, or “recording heads”). Each head includes a plurality of nozzles that are arrayed in one or more rows in a given direction (hereinafter “nozzle array direction”). In such a line-type head unit, for example, the plurality of liquid discharge heads may be staggered in a direction perpendicular to a conveyance direction of a sheet so that a nozzle array direction in each head is perpendicular to the sheet conveyance direction.

Alternatively, the plurality of liquid discharge heads may be inclined with respect to the sheet conveyance direction so that a nozzle array direction in each head is inclined at a certain angle to the sheet conveyance direction.

Such liquid discharge heads may discharge liquid droplets through minute nozzle orifices having a diameter of, for example, 50 μm or less, and thus it may be difficult to maintain the nozzle orifices in a normal operational state. In particular, some line-type head units have hundreds or thousands of nozzles, making it more difficult to maintain all the nozzles in a normal state while avoiding various discharge failures.

For example, in one conventional image forming apparatus having a head unit in which a plurality of liquid discharge heads are staggered, when a discharge failure occurs in a nozzle of one head, the image forming apparatus pressurizes or suctions liquid stored in the head. Thus, the liquid is ejected from the nozzles to a nozzle face of the head and is wiped out with a wiping member.

However, for such a head unit in which the liquid discharge heads are staggered, a head having a discharge failed nozzle (hereinafter “failed head”) and a head having no discharge failed nozzle (hereinafter “normal head”) have an overlapping area in a wiping direction of the wiping member. The wiping member wipes the failed head and then the normal head in one wiping operation.

Consequently, a portion of the ink ejected to the nozzle face may be attached to the wiping member and may be intruded into a nozzle of the normal head, thereby resulting in a discharge failure in the normal nozzle.

In this regard, a further description is given below with reference to FIGS. 1, 2, and 3A to 3D.

As illustrated in FIG. 1, a head unit 500 includes twelve liquid discharge heads 511A to 511L that are staggered in two straight lines. A wiping member 504 wipes the liquid discharge heads 511A and 511B in a direction perpendicular to array directions of nozzle arrays 512A and 512B, which include a plurality of nozzles 512a and 512b, respectively.

As illustrated in FIG. 2, the nozzles 512a and the nozzles 512b have an overlapping area 505 in a wiping direction WD. If a discharge failure occurs in the nozzles 512b of the liquid discharge head 511B, the wiping member 504 is moved from the liquid discharge head 511B to the liquid discharge head 511A in the wiping direction WD. In this wiping operation, the wiping member 504 wipes the liquid discharge head 511B as well as the liquid discharge head 511A in the overlapping area 505. In such a case, even when the length of the wiping member 504 is identical to the length of one liquid discharge head 511, the wiping member 504 wipes both the liquid discharge head 511B and the liquid discharge head 511A in the overlapping area 505.

In such a configuration, as illustrated in FIG. 3A, a discharge failure may occur in the nozzles 512b of the liquid discharge head 511B while the nozzles 512a of the liquid discharge head 511A are in a normal state. In a maintenance operation, as illustrated in FIG. 3B, ink is ejected from the defective nozzles 512b of the liquid discharge head 511B and the wiping member 504 wipes such ejected ink 521 as waste ink 522 as illustrated in FIG. 3C. In this wiping operation, such waste ink 522 passes beneath the nozzles 512a of the liquid discharge head 511A having no failed nozzles. Consequently, as illustrated in FIG. 3D, a portion 522a of the waste ink 522 may intrude into the nozzles 512a of the liquid discharge head 511A and contaminate ink in the nozzles 512a, resulting in a discharge failure in the liquid discharge head 511A.

In such a head unit, an increase in the nozzle density may make it more difficult to separately wipe the liquid discharge heads. Consequently, a normal head may be wiped together with a failed head, resulting in a failure in one or more additional nozzles of the normal head.

Further, if ink is absent from a nozzle face during the wiping operation, the function of the ink as lubricant is unavailable. Consequently, the friction between the wiping member and the nozzle face might be increased, resulting in wear-out of one end surface of the wiping member in contact with the nozzle face, or deterioration or peeling of a water-shedding coating on the nozzle face. Therefore, the above-described ink ejecting operation may need to be performed before wiping.

For example, one conventional image forming apparatus employs a recovery method in which a plurality of liquid discharge heads are sequentially suctioned by switching a plurality of valves for cap members. In such a recovery method, a normal head and a failed head are equally suctioned, thereby increasing waste ink. Further, such an increase of waste ink increases the number of times of replacement of the waste liquid container, thereby imposing more load on the environment.

### BRIEF SUMMARY

The present disclosure provides an image forming apparatus capable of reliably recovering from a discharge failure with less waste liquid.

In an aspect of the present disclosure, an image forming apparatus includes a head unit, a cap unit, a suction device, a wiper unit, and a control unit. The head unit includes a plurality of liquid discharge heads to discharge liquid droplets. Each liquid discharge head has a nozzle face on which a plurality of nozzles are formed. The liquid discharge heads are arranged parallel to a direction in which the plurality of nozzles are arrayed. The cap unit caps the nozzle faces of the liquid discharge heads. The suction device suctions an inside of the cap unit while the nozzle faces of the liquid discharge heads are capped with the cap unit. The wiper unit wipes the nozzle faces of the liquid discharge heads in a manner that a portion of one nozzle face is wiped after a portion of another nozzle face is wiped. The control unit controls a maintenance operation of the liquid discharge heads by selecting a first ejection operation and a second ejection operation. The control unit controls the first ejection operation to eject a first amount of liquid from a first liquid discharge head having a discharge failed nozzle among the plurality of liquid discharge heads, and controls the second ejection operation to eject a second amount of liquid, which is less than the first amount, from a second liquid discharge head having no discharge failed nozzle among the plurality of liquid discharge heads.

Additional features and advantages will be more fully apparent from the following detailed description, the accompanying drawings, and the associated claims.

### BRIEF DESCRIPTION OF THE DRAWINGS

A more complete appreciation of the subject matter of the present invention and many of the attendant advantages thereof will be readily obtained as the same becomes better understood by reference to the following detailed description when considered in connection with the accompanying drawings, wherein:

FIG. 1 is a schematic view illustrating a head unit and a wiper in an image forming apparatus according to a comparative example;

FIG. 2 is an enlarged view illustrating an overlapping area between wiping areas of different heads in the head unit of FIG. 1;

FIGS. 3A to 3D illustrate a wiping operation in the overlapping area of FIG. 2;

FIG. 4 is a schematic view illustrating a configuration of an image forming apparatus according to a first exemplary embodiment of the present disclosure.

FIG. 5 is a perspective view illustrating a portion of the image forming apparatus of FIG. 4;

FIG. 6 is a perspective view illustrating a head unit and a maintenance unit of the image forming apparatus of FIG. 4;

FIG. 7 is a plan view illustrating the head unit of FIG. 6 from a nozzle face side in one example;

FIG. 8 is an enlarged plan view illustrating a liquid discharge head of the head unit of FIG. 7 from the nozzle face side;

FIG. 9 is an enlarged plan view illustrating a liquid discharge head and its surrounding portion of the head unit of FIG. 7 from the nozzle face side;

FIG. 10 is a plan view illustrating the head unit of FIG. 6 from a nozzle face side in another example;

FIG. 11 is an enlarged plan view illustrating a liquid discharge head of the head unit of FIG. 10 from the nozzle face side;

FIG. 12 is an enlarged view illustrating color assignment for nozzle arrays of liquid discharge heads in the head unit of FIG. 10;

FIG. 13 is a plan view illustrating the head unit and a wiper unit in another example of the image forming apparatus;

FIG. 14 is a plan view illustrating a wiping range of the wiper unit of FIG. 13;

FIG. 15 is a schematic view illustrating a configuration of an ink path according to the first exemplary embodiment;

FIG. 16 illustrates a configuration of a suction pump of the image forming apparatus of FIG. 4;

FIGS. 17A to 17B illustrate another configuration of the suction pump;

FIG. 18 is a block diagram illustrating a control unit of the image forming apparatus of FIG. 4;

FIG. 19 is a flowchart illustrating a maintenance-and-recovery process for a head of a head unit of the image forming apparatus of FIG. 4;

FIGS. 20A to 20H illustrate a configuration of a relative movement between a head unit and a maintenance unit in the image forming apparatus of FIG. 4;

FIGS. 21A to 21H illustrate another configuration of a relative movement between a head unit and a maintenance unit in the image forming apparatus of FIG. 4;

FIG. 22 is a flowchart illustrating a first example of a maintenance operation;

FIG. 23 is a flowchart illustrating a second example of a maintenance operation;

FIG. 24 is a flowchart illustrating a third example of a maintenance operation;

FIG. 25 is a flowchart illustrating a fourth example of a maintenance operation;

FIG. 26 is a flowchart illustrating a first example of an ink ejection process;

FIG. 27 is a flowchart illustrating a second example of an ink ejection process;

FIG. 28 is a flowchart illustrating a third example of an ink ejection process;

FIG. 29 is a flowchart illustrating a fourth example of an ink ejection process;

FIG. 30 is a flowchart illustrating a fifth example of an ink ejection process;

FIG. 31 is a flowchart illustrating a sixth example of an ink ejection process;

FIG. 32 is a flowchart illustrating a seventh example of an ink ejection process;

FIG. 33 is a flowchart illustrating an example of an ejection mode process;

FIG. 34 is a flowchart illustrating an example of a suction operation process;

FIG. 35 is a flowchart illustrating a first example of a suction-pump drive operation process;

FIG. 36 is a flowchart illustrating a second example of a suction-pump drive operation process;

FIG. 37 is a flowchart illustrating a third example of a suction-pump drive operation process;

FIG. 38 illustrates an overlapping area between wiping areas of different heads;

FIGS. 39A to 39D illustrate a wiping operation in the overlapping area;

FIG. 40 is a schematic view illustrating an ink path according to a second exemplary embodiment;

FIG. 41 is a flowchart illustrating a second example of a suction operation process;

FIG. 42 is a schematic view illustrating an ink path according to a third exemplary embodiment;

FIG. 43 is a flowchart illustrating a third example of a suction operation process;

FIG. 44 is a schematic view illustrating an ink path according to a fourth exemplary embodiment;

FIG. 45 is a flowchart illustrating a second example of an ejection mode process in the fourth exemplary embodiment;

FIG. 46 is a flowchart illustrating a first example of a supply-operation start process;

FIG. 47 is a flowchart illustrating a first example of a supply-operation stop process;

FIG. 48 is a flowchart illustrating a third example of an ejection mode process;

FIG. 49 is a flowchart illustrating a second example of a supply-operation start process;

FIG. 50 is a flowchart illustrating a fourth example of a suction operation process;

FIG. 51 illustrates a correspondence table used in the suction operation process of FIG. 50;

FIG. 52 is a flowchart illustrating a second example of a supply-operation stop process;

FIG. 53 is a graph illustrating differences in the waste amount of liquid between suction sections;

FIG. 54 is a schematic view illustrating an ink path according to a sixth exemplary embodiment;

FIG. 55 is a flowchart illustrating a third example of a supply-operation start process;

FIG. 56 is a flowchart illustrating a fifth example of a suction operation process;

FIG. 57 is a correspondence table used in the suction operation process of FIG. 56;

FIG. 58 is a flowchart illustrating a third example of a supply-operation stop process;

FIG. 59 is a schematic view illustrating an ink path according to a seventh exemplary embodiment;

FIG. 60 is a schematic view illustrating an ink path according to an eighth exemplary embodiment;

FIG. 61 illustrates differences in the amount of waste ink between the presence and absence of resistance;

FIG. 62 illustrates differences in the amount of waste ink among suction pressures;

FIGS. 63A to 63C illustrate a movement configuration of a head unit and a maintenance unit according to a ninth exemplary embodiment; and

FIGS. 64A to 64D illustrate a subsequent movement configuration of FIGS. 63A to 63C.

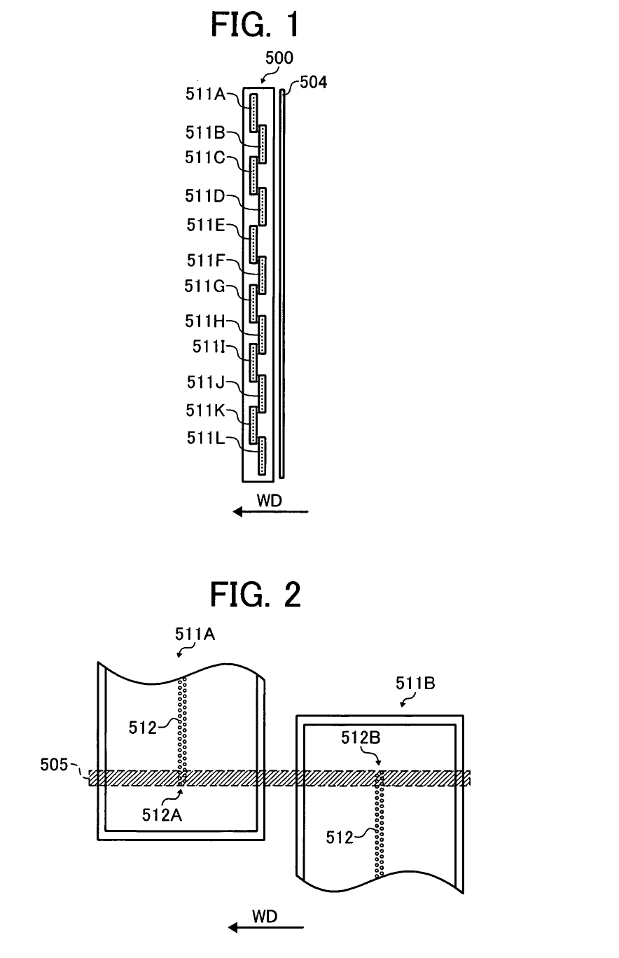

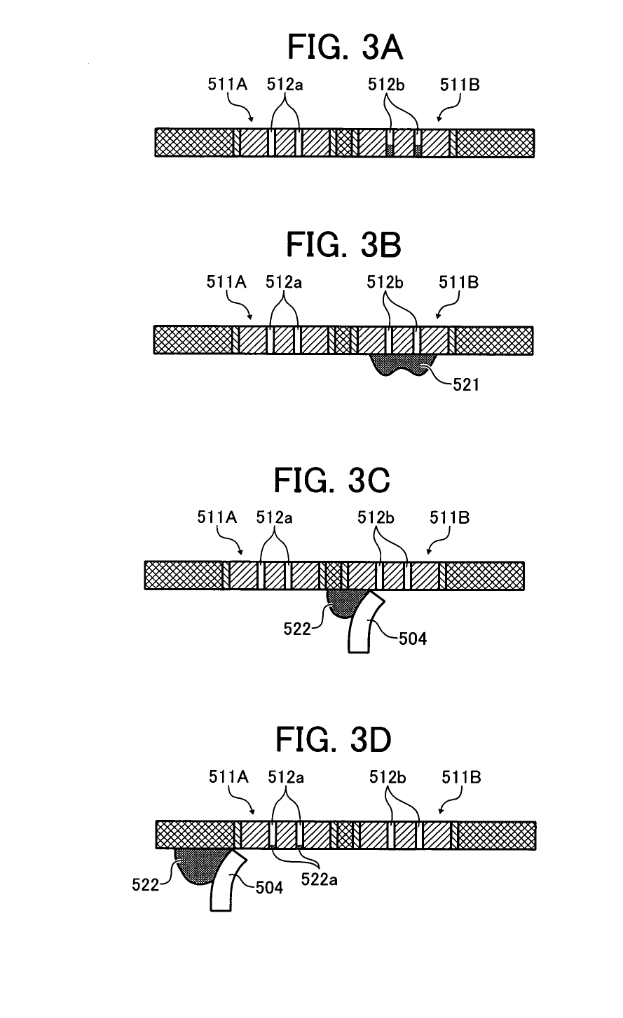

### DETAILED DESCRIPTION OF EXEMPLARY EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. For the sake of simplicity, the same reference numerals are used in the drawings and the descriptions for the same materials and constituent parts having the same functions, and redundant descriptions thereof are omitted.

Exemplary embodiments of the present disclosure are now described below with reference to the accompanying drawings. It should be noted that, in a later-described comparative example, exemplary embodiment, and alternative example, the same reference numerals are used for the same constituent elements such as parts and materials having the same functions, and redundant descriptions thereof are omitted.

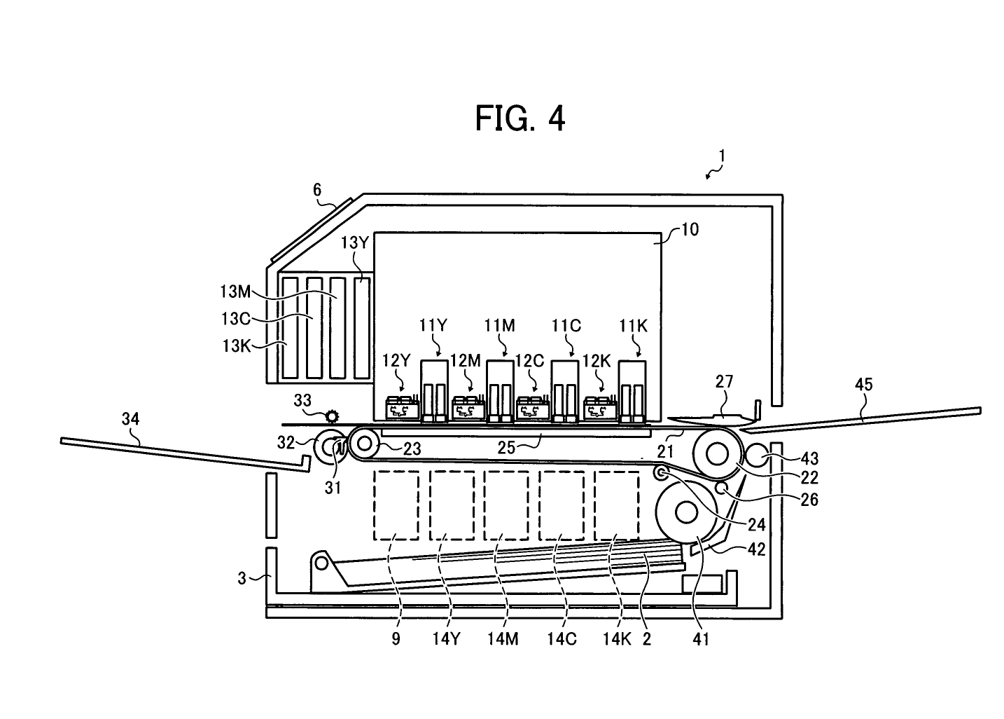

First, an image forming apparatus of a first exemplary embodiment is described with reference to FIGS. 4 to 6.

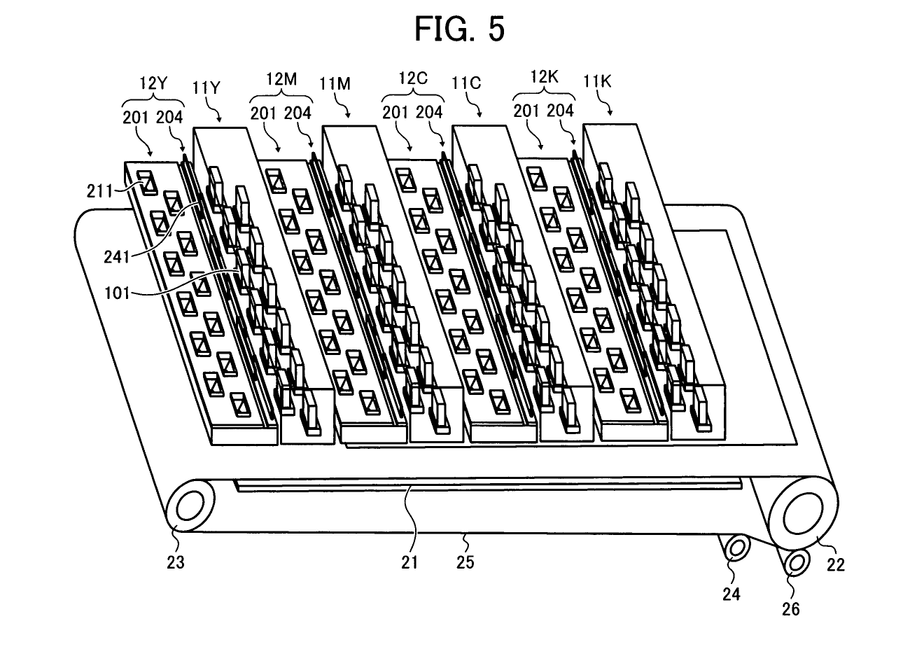

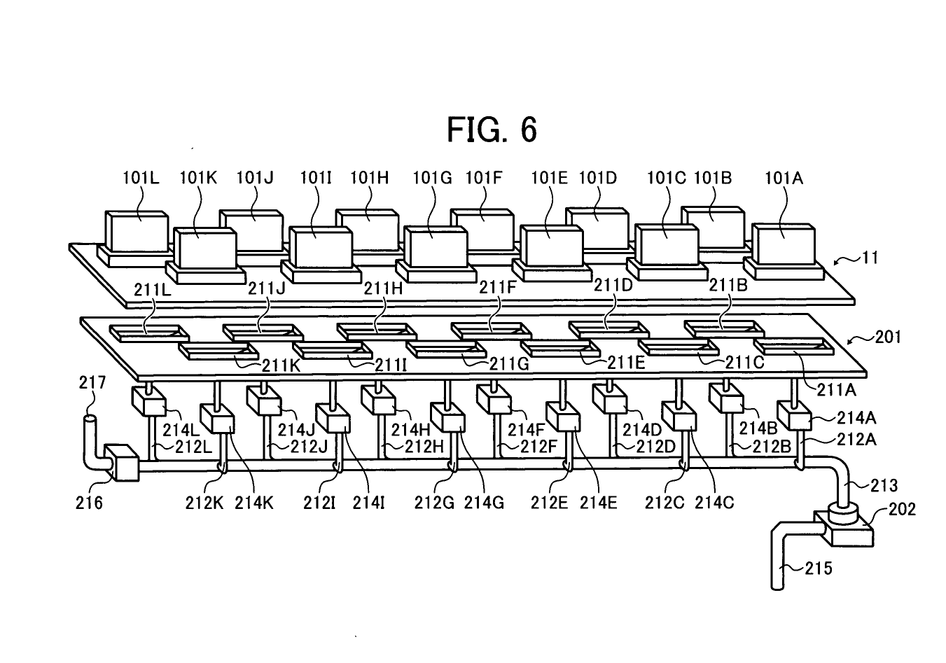

FIG. 4 is a schematic view illustrating a configuration of an image forming apparatus 1 according to the first exemplary embodiment. FIG. 5 is a perspective view illustrating a portion of the image forming apparatus 1. FIG. 6 is a perspective view illustrating a head unit and a maintenance unit of the image forming apparatus 1.

As illustrated in FIGS. 4 to 6, the image forming apparatus 1 may have a head holder 10 to hold a plurality of head units 11K, 11C, 11M, and 11Y (hereinafter referred to as “head units 11” without the subscripts indicating colors, if needed) and a plurality of maintenance units 12K, 12C, 12M, and 12Y. Each head unit 11 is a line-type head unit that includes a plurality of liquid discharge heads or recording heads 101A to 101L (hereinafter “head” or “heads”) to discharge color inks of black, cyan, magenta, and yellow. The plurality of maintenance units 12K, 12C, 12M, and 12Y perform maintenance and recovery operations on the plurality of head units 11K, 11C, 11M, and 11Y, respectively. Each maintenance unit 12 includes a cap unit 201, a suction pump 202, and a wiper unit 204.

Further, the image forming apparatus 1 may include a plurality of ink cartridges 13K, 13C, 13M, and 13Y and a plurality of subsidiary reservoirs 14K, 14C, 14M, and 14Y. Each of the ink cartridges 13K, 13C, 13M, and 13Y stores a color ink for supply to the heads 101A to 101L of the corresponding head unit 11. Each of the subsidiary reservoirs 14K, 14C, 14M, and 14Y temporarily stores the color ink supplied from the corresponding ink cartridge 13, and supplies the color ink to the heads 101A to 101L of the corresponding head unit 11 with an appropriate pressure.

The image forming apparatus 1 also includes a conveyance section. As illustrated in FIG. 4, the conveyance section may have a conveyance belt 21 to attract and convey a recording medium (hereinafter “sheet”), conveyance rollers 22 and 23 over which the conveyance belt 21 is stretched, a tension roller 24 to provide an appropriate tension to the conveyance belt 21, a platen 25 to provide an appropriate flatness to the conveyance belt 21, a charge roller 26 to charge the conveyance belt 21 so that the conveyance belt 21 electrostatically attracts a sheet 2 thereon, and a press member 27 to press the sheet 2 against the conveyance belt 21 at a position opposite the conveyance roller 22.

The image forming apparatus 1 also includes a sheet output mechanism. As illustrated in FIG. 4, the sheet output mechanism may have a separation claw 31 to separate the sheet 2 from the conveyance belt 21, an output roller 32 to output the sheet 2 to the outside of the image forming apparatus 1, a spur 33 disposed opposite the output roller 32, and a catch tray 34 to receive the sheet 2.

The image forming apparatus 1 further includes a sheet feeding mechanism. As illustrated in FIG. 4, the sheet output mechanism may have a feed tray 3 to store a stack of sheets 2, a feed roller 41 and a separation pad 42 that work together to separate and feed the sheets 2 one by one from the feed tray 3, a counter roller 43 to reliably attach the sheet 2 on the conveyance belt 21, and a manual feed tray 45 to manually feed a sheet.

Further, the image forming apparatus 1 includes a waste liquid tank 9, described later, and an operation panel 6.

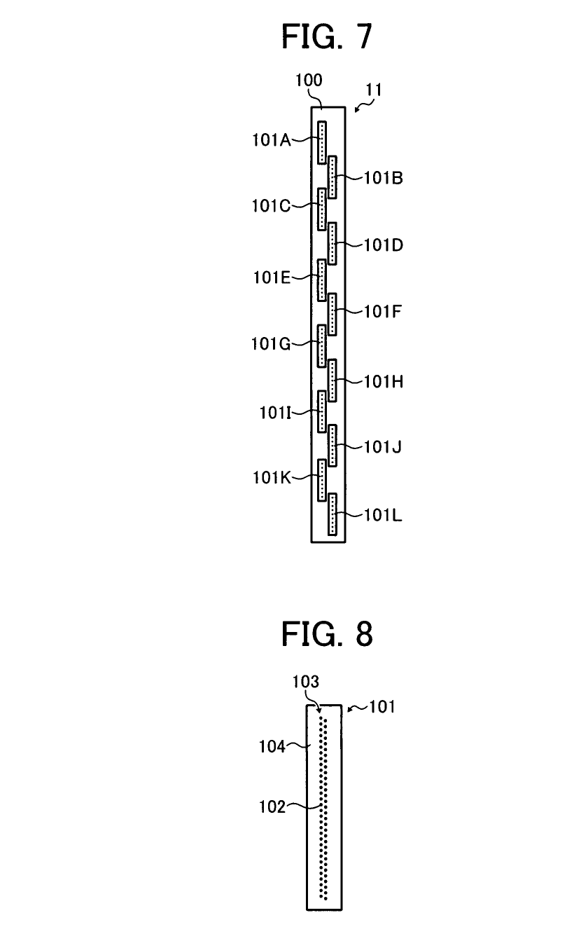

Next, a configuration of a head unit 11 that can be used in the image forming apparatus 1 is described with reference to FIGS. 7 and 8.

FIG. 7 is a plan view of the head unit 11 seen from a nozzle face side. FIG. 8 is an enlarged plan view of one liquid discharge head of the head unit 11 seen from the nozzle face side.

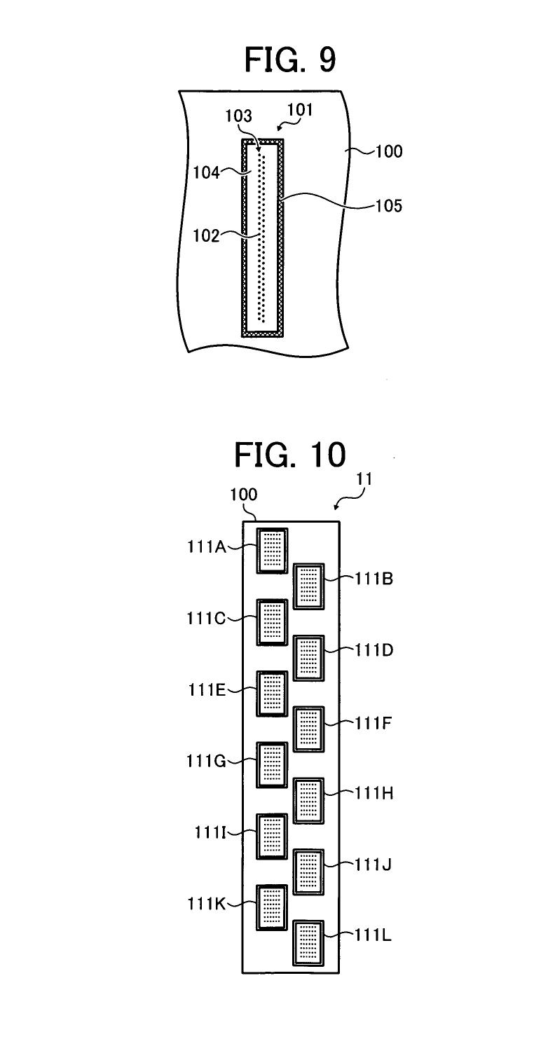

As illustrated in FIG. 7, the head unit 11 may have twelve liquid discharge heads 101A to 101L. The liquid discharge heads 101A to 101L may also be arranged in two straight lines in a nozzle array direction of nozzles 102, that is, an extending direction of a nozzle array 103. The liquid discharge heads 101A to 101L are also staggered so that adjacent heads thereof partially overlap in the nozzle array direction. Each liquid discharge head 101 has a nozzle face on which a plurality of nozzles 102 are staggered in two straight lines, in the example illustrated in FIG. 8. As illustrated in FIG. 9, filling agent 105 is filled between the head support 100 and each liquid discharge head 101 to seal a clearance on the nozzle face 104.

The head support 100 and the nozzle face 104 are fixedly positioned on an identical plane. If there were a step between the nozzle face 104 and the head support 100, a wiping member of the wiper unit 204 would be caught in the step during a wiping operation. Consequently, the wiping member might be prevented from contacting the nozzle face 104 with an even force, thereby resulting in incomplete wiping. Further, ink might easily accumulate in a dead space which the wiping member cannot touch. Such accumulated ink might fall onto a sheet 2 during printing, thereby degrading image quality. Moreover, such a step might increase a pressure locally against the wiping member and increase a friction between the wiping member and the nozzle face 104, resulting in wear-out of one end surface of the wiping member in contact with the nozzle face 104. Hence, in the first exemplary embodiment, the head support 100 and the nozzle face 104 are fixedly disposed on an identical plane.

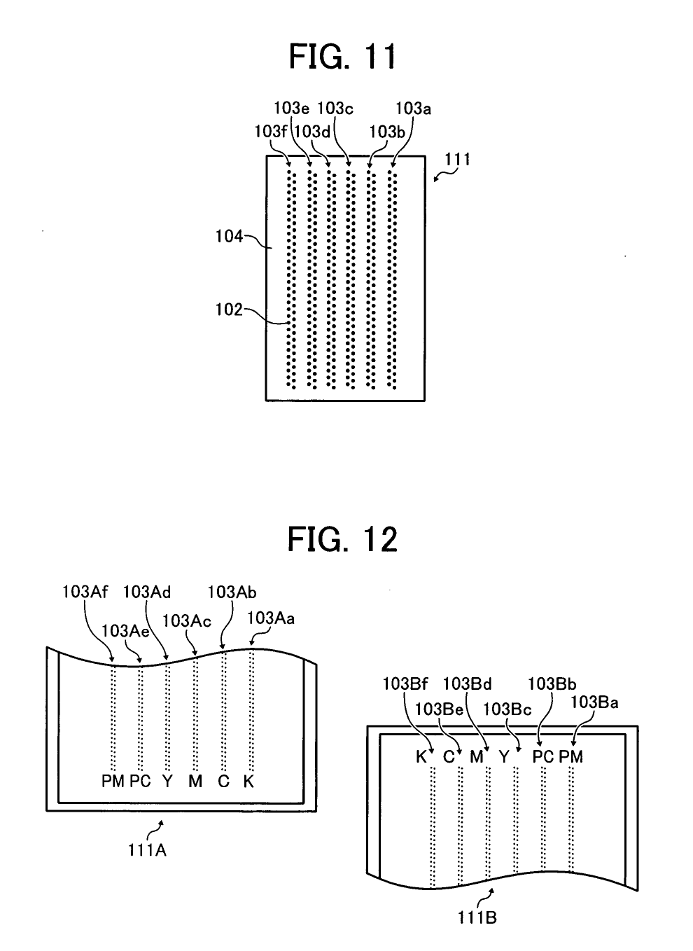

Next, another exemplary configuration of the head unit 11 of the image forming apparatus 1 is described with reference to FIGS. 10 and 11.

FIG. 10 is a plan view of the head unit 11 seen from a nozzle face side. FIG. 11 is an enlarged plan view of one liquid discharge head of the head unit 11 seen from the nozzle face side.

As illustrated in FIG. 10, the head unit 11 has twelve liquid discharge heads 111A to 111L on a head support 100. The liquid discharge heads 111A to 111L are arranged in two straight lines in a nozzle array direction of nozzles 102. The liquid discharge heads 111A to 111L are also staggered so that adjacent heads thereof partially overlap in the nozzle array direction. Each liquid discharge head 111 has a nozzle face 104 on which a plurality of nozzle arrays 103a to 103f are formed. In each nozzle array 103, the plurality of nozzles 102 are staggered in two straight lines. Similar to the example of FIGS. 7 to 9, filling agent is filled between the head support 100 and the liquid discharge head 111 to seal a clearance on the nozzle face 104.

By using different color inks for the nozzle arrays 103a to 103f, the head unit 11 facilitates multi-colorization of the image forming apparatus 1 without upsizing. Alternatively, by using a single color ink for all the nozzle arrays 103a to 103f, the head unit 11 can discharge the single color ink from the plurality of nozzle arrays 103a to 103f, thereby enhancing printing speed.

Further, when the above-described multi-colorization is implemented on the head unit 11, a relatively high accuracy in landing position can be obtained between liquid droplets discharged from adjacent nozzle arrays. Therefore, a deep color ink may be assigned at a position closer to a central portion of the head unit 11 while a light color ink is assigned at a position closer to a peripheral portion thereof. For example, as illustrated in FIG. 12, when six color inks including photo-cyan (PC) and photo-magenta (PM) are used in a liquid discharge head 11A, the six color inks may be assigned in an order of PM, PC, Y, M, C, and K from an exterior nozzle array 103Af to an interior nozzle array 103Aa. On the other hand, in the liquid discharge head 111B, the six color inks may be assigned in an order of PM, PC, Y, M, C, and K from an exterior nozzle array 103Ba to an interior nozzle array 103Bf.

In the image forming apparatus 1 having such a configuration, the nozzle arrays 103 of each head unit 11 are arranged perpendicular to a sheet conveyance direction so as to have a width longer than a width of a recordable area of each head unit 11. A stack of sheets 2 stored in the feed tray 3 is separated and fed one by one by the feeding roller 41. When the counter roller 43 guides the sheet 2 toward the conveyance belt 21, the sheet 2 is electrostatically attracted on the conveyance belt 21. While the sheet 2 is passing under the head unit 11, the head unit 11 discharges liquid droplets to form a desired image on the sheet 2. The sheet 2 having the image is separated by the separation claw 31 from the conveyance belt 21 and is output by the output roller 32 and the spur 33 to the catch tray 34.

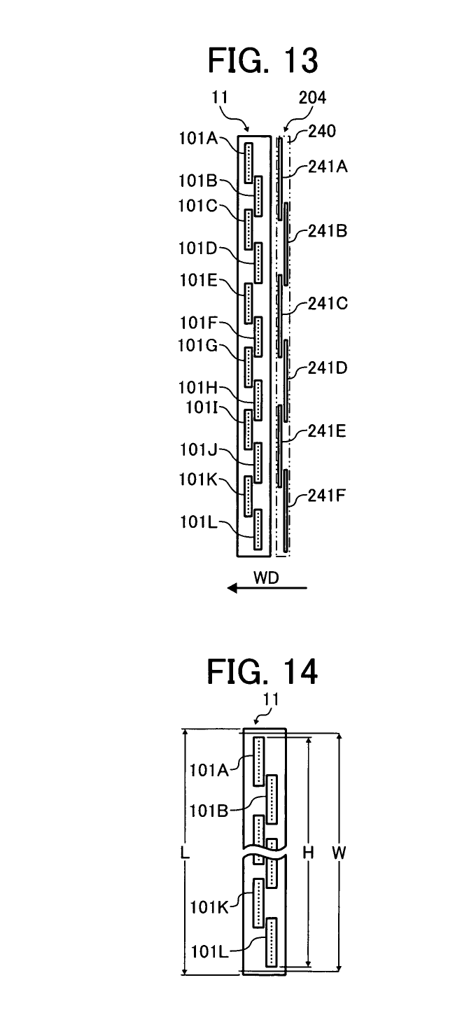

Next, configurations of the head unit 11 and the maintenance unit 12 are further described with reference to FIGS. 13 and 14 and additionally to FIG. 6.

As described above, in each head unit 11, the liquid discharge heads 101A to 101L are staggered in two lines. It should be noted that the liquid discharge heads 111A to 111L may be used instead of the liquid discharge heads 101A to 101L, which can also be applied to configurations described later.

The maintenance units 12K to 12Y are provided corresponding to the head units 11K to 11Y, respectively. Each maintenance unit 12 has a cap unit 201, a suction pump 202 serving as a suction device, and a wiper unit 204.

The cap unit 201 includes a plurality of cap members 211A to 211L that are disposed on a support member 210 so as to correspond to the liquid discharge heads 101A to 101L, respectively. The cap members 211A to 211L, serving as suction sections, separately cap (i.e. contact and seal) the liquid discharge heads 101A to 101L on the nozzle face 104 of each head unit 11.

The cap members 211A to 211L are communicated with the suction pump 202 via separate suction paths 212A to 212F and a common suction path 213. The separate suction paths 212A to 212F are provided with valves 214A to 214F to open and close between the suction pump 202 and the cap members 211A to 211L. An air release opening 207 is provided at one end portion of the common suction path 213 on a side opposite the suction pump 202.

In such a configuration, when the air release valve 216 is closed and the suction pump 202 is activated while the nozzle faces 104 of the heads 101A to 101L are capped with the cap members 211A to 211L, a negative pressure is generated in the capped spaces. Thus, ink is ejected from the respective nozzles 102 of the heads 101A to 101L into the cap members 211A to 211L, respectively. Such ejected ink is sent through the separate suction paths 212A to 212F and the common suction path 213 to the suction pump 202 and is ejected into the waste liquid tank 9. In this regard, if the image forming apparatus 1 employs a configuration capable of circulating and reusing such ejected ink, the amount of waste ink can be significantly reduced, resulting in a higher printing efficiency.

As illustrated in FIG. 13, the wiper unit 204 may include, for example, six wiping members 241A to 241F (e.g., wiping blades). The wiping members 241A to 241F are staggered on a support 240 so that each wiping member wipes two heads of the heads 101A to 101L. In such a configuration, when the heads 101A to 101L are wiped with the wiper unit 204, nozzle faces of adjacent heads thereof partially overlap in a wiping direction WD of the wiper unit 204.

In such a case, as illustrated in FIG. 14, a wiping range W of the wiper unit 204 is shorter than a length L of the head unit 11 (i.e. the support 100) in its long direction and is longer than a length H between outer end faces of the heads 101A and 101L, which are disposed on both end portions of the head unit 11.

In the above description, the wiper unit is formed by the six wiping members. It should be noted that the number of wiping members is not limited to six and may be any suitable number. For example, the number of the wiping member may be one, or identical to the number of the liquid discharge heads.

Further, in FIG. 13, the wiping members are formed in a blade shape. However, it should be noted that the shape of the wiping members is not limited to a blade shape and may be any suitable shape capable of reliably wiping the nozzle faces.

The cap members 211 may be integrally formed on or separately formed from the maintenance unit 201. The cap members 211 are preferably capable of closely contacting the corresponding heads 101 and may be formed by patterning a single elastic member so as to have concave portions in accordance with the heads 101.

The cap members 211 are made of any suitable material having a close contact with the nozzle faces 104, a high ink resistance, and a moisture permeability of 5×10⁻⁷g/mm²/h or less at 20° C. and 60% RH. For example, the material may be fluorocarbon rubber or butyl rubber. The thickness of the cap members 211 may be typically 1 mm to 5 mm, preferably 1.5 mm to 3 mm in consideration of workability and endurance. However, it should be noted that the thickness is not limited to the above ranges and may be any suitable value.

Similar to the cap members 211, the wiping members 241 are made of any suitable material having a high ink resistance. Preferably, such material is resistant to the sliding friction with the nozzle face 104 and does not significantly wear the nozzle face 104 out during sliding. The surface of the wiping member 241 should have an ink repellency that is lower than that of the nozzle face 104 and does not easily accumulate ink thereon. Additives may be added to such material to obtain a higher strength or stiffness. However, it should be noted that such additives might microscopically increase the hardness of material, thereby damaging the nozzle face 104.

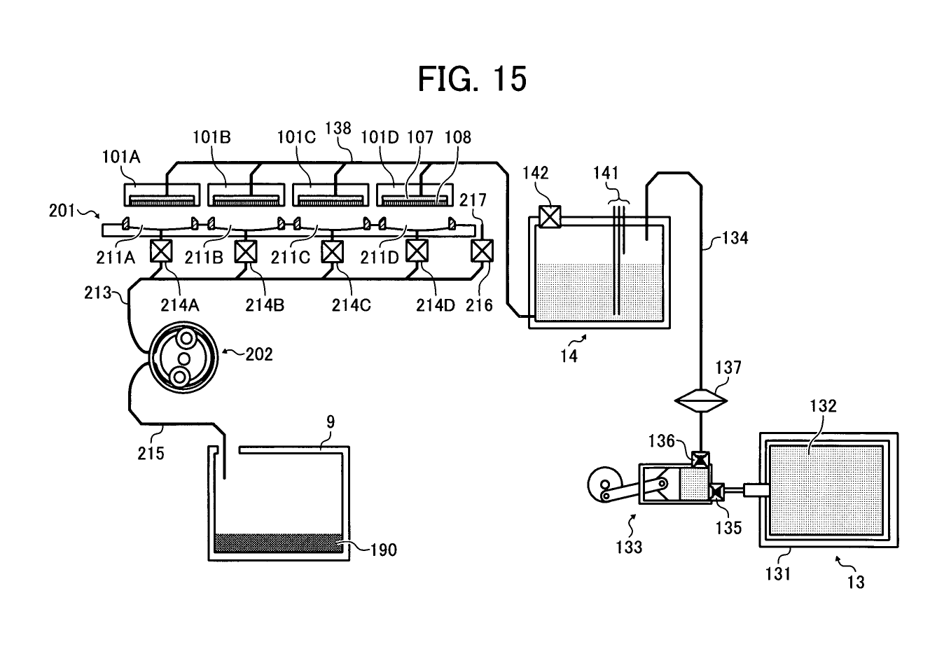

Next, an ink path in the image forming apparatus according to the first exemplary embodiment is described with reference to FIG. 15.

FIG. 15 is a schematic view illustrating a configuration of the ink path. In FIG. 15, only four liquid discharge heads 101A to 101D are illustrated as the liquid discharge heads 101 of the head unit 11 for the sake of simplicity, which is also applied to the following schematic views illustrating different configurations of the ink path.

The ink cartridge 13 includes a cartridge case 131. An ink bag 132 storing ink is housed in the cartridge case 131. The ink cartridge 13 is mounted to the apparatus body so that the ink bag 132 is communicated with an ink supply path provided to the image forming apparatus 1. The ink bag 132 serves as an inner bag to block ink from ambient air, thereby preventing ink from deteriorating due to oxidation. Alternatively, each ink cartridge 13 may be provided with an air communication channel in order to store ink without an inner bag.

The ink stored in the ink bag 132 is supplied using a supply pump 133, which is driven by an ink supply motor 318, to a subsidiary reservoir 14 via an ink supply path 134. The ink is temporarily stored in the subsidiary reservoir 14. A check valve 135 is disposed at an entry portion at which the ink flows from the ink cartridge 13 into the supply pump 133 while a check valve 136 is disposed at an exit portion at which the ink flows from the supply pump 133 to the ink supply path 134. The ink supply path 134 is provided with a filter 137 to filter coarse particles for enhancing discharge reliability.

The supply pump 133 may be a diaphragm pump, tubing pump, or any suitable liquid-sending pump. The supply pump 133 is made of any suitable material resistant to corrosion, swelling, and dissolving due to exposure to ink.

The filter 137 has a mesh of, for example, 20 μm or lower, preferably 10 μm or lower. It should be noted that the more refined the mesh, the greater fluid resistance the filter 137 has, and thus the greater load may be imposed on the supply pump 133.

The subsidiary reservoir 14 may include an electrode sensor 141. The electrode sensor 141 has a plurality of sensing electrodes to detect the amount of ink stored in the subsidiary reservoir 14. The electrode sensor 141 detects whether or not the amount of ink in the subsidiary reservoir 14 is beyond a certain amount on the basis that, when the sensing electrodes come into contact with ink, the conductivity between the sensing electrodes changes.

Detection results of the electrode sensor 141 are transmitted to a central processing unit (CPU) 301 via an input-and-output interface (I/O) 322 of a controller unit 300, which are described later. If the amount of ink stored in the subsidiary reservoir 14 is beyond a certain value, the CPU 300 causes a controller 316 to stop an ink supply motor 318. As a result, the driving of the supply pump 133 is stopped so as to halt ink supply. Thus, a certain amount of ink is maintained in the subsidiary reservoir 14.

The electrode sensor 141 may include two electrodes to measure one level as described above, or three or more electrodes to measure a plurality of levels. Alternatively, instead of the electrode sensor 141, the amount of ink in the subsidiary reservoir 14 may be detected by any suitable type of sensor. For example, the amount of ink may be detected based on the electrostatic capacitance of the ink or may be optically detected based on the permeability or refractive index of the ink. Alternatively, the amount of ink may be magnetically detected by using float and magnet.

The subsidiary reservoir 14 is also provided with an air release valve 142. The air release valve 142 is opened while ink is flowed into and out of the subsidiary reservoir 14, for example, while ink is supplied from the ink cartridge 13 into the subsidiary reservoir 14 or while a printing operation is performed. Thus, the inside of the subsidiary reservoir 14 is maintained at a pressure substantially identical to atmospheric pressure.

The ink stored in the subsidiary reservoir 14 is supplied to a common chamber 107 of each head 101 of the head unit 11. By using a water head difference, or a valve or pump, a negative pressure should be automatically or actively applied to an ink supply path 138 between the subsidiary reservoir 14 and each head 101 of the head unit 11. Thus, a pressure greater than a surface tension of the ink can be obtained to prevent the ink from leaking from the nozzles 102 of each head 101. Meanwhile, in order to supply the ink in response to a printing or maintenance operation, the ink path of the image forming apparatus 1 may need to have a piping area that reliably supplies the ink even when the ink is used at a maximum level.

Further, the image forming apparatus 1 may have a circulating system to supply the ink from the subsidiary reservoir 14 to each head 101 and return the ink from each head 101 to the subsidiary reservoir 14. In such a configuration, the ink is prevented from staying in the head 101 and air bubbles, which might cause a discharge failure, can be removed from each head 101.

The ink having been supplied to each head 101 is forwarded from the common chamber 107 to separate chambers 108 communicating with respective nozzles 102. The ink in each separate chamber 108 is pressurized with a pressure generated by a pressure generator (e.g., an actuator) so as to discharge droplets of the ink from each nozzle 102. The pressure generator may be a piezoelectric actuator, thermal actuator, or electrostatic actuator.

In such a maintenance operation, before ink is ejected from each head 101, the cap members 211 are brought into close contact with the nozzle faces 104 of each head 101 in order to receive the ink. The ink received at the cap members 211 are further forwarded through the valves 214, which are disposed on downstream sides of the corresponding cap members 211, the separate suction paths 212, and the common suction path 213 to the suction pump 202.

During its suction operation, the suction pump 202 is rotationally driven by a cap suction motor 317 to pump out the ink through a waste liquid path 215 to the waste liquid tank 9. The ink stored in the waste liquid tank 9 is discarded as waste ink 190 when replacing the tank with another. The common suction path 213 is opened at an air release opening 217 using an air release valve 216. The air release opening 217 releases a pressure of the common suction path 213 in the suction operation of the suction pump 202 or a removal operation of residual ink in the common suction path 213.

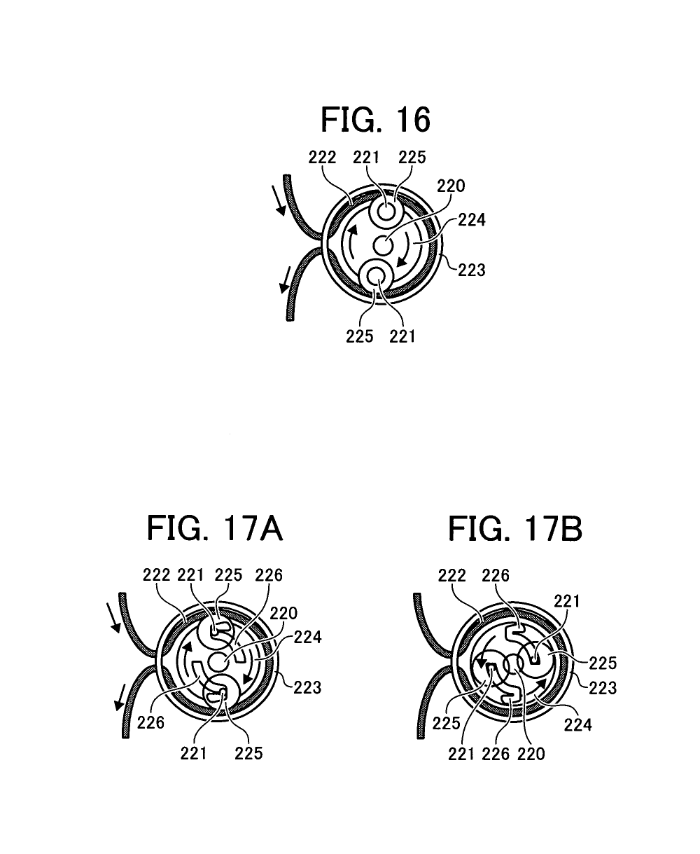

Next, configurations of a tubing pump serving as the suction pump 202 are described with reference to FIGS. 16, 17A and 17B.

In a tubing pump of FIG. 16, an elastic tube 222 forming the common suction path 213 is led into a circular pump case 223 and guided along an internal surface of the circular pump case 223. In the circular pump case 223, a pump wheel 224 rotates around a rotation shaft 220. Rollers 225, supported on support shafts 221, are provided to the pump wheel 224 so as to press the tubes 222. With the rotation of the pump wheel 224, the rollers 225 roll while pressing the tube 222 and thus ink or other liquid remaining in the tube 222 is pushed out in the rotation direction of the pump wheel 224. In such a configuration, the rollers 225 continuously press the tube 222 at any two portions, and thus the movement of the ink in the tube 222 is significantly limited between the inlet and outlet of the tubing pump.

Alternatively, in a tubing pump of FIGS. 17A and 17B, support shafts 221 of rollers 225 move along guide grooves 226 of a pump wheel 224. The tubing pump performs pumping and releasing operations depending on rotation directions of the pump wheel 224.

In other words, as illustrated in FIG. 17A, the rollers 225 roll over the tube 222 while pressing the tube 222, and thus the tubing pump performs a function of sending ink in one direction. On the other hand, during a reverse rotation as illustrated in FIG. 17B, the rollers 225 move to positions closer to a central portion of the pump wheel 224 so as to release such a pressure. As a result, on the reverse rotation, the liquid in the tube 222 is movable between the inlet and outlet of the tubing pump in a relatively free manner and the pressure generated by the liquid sending operation can be released. With the tubing pump illustrated in FIGS. 17A and 17B, such a suction pressure can be released to the air without using the air release valve 216 described above.

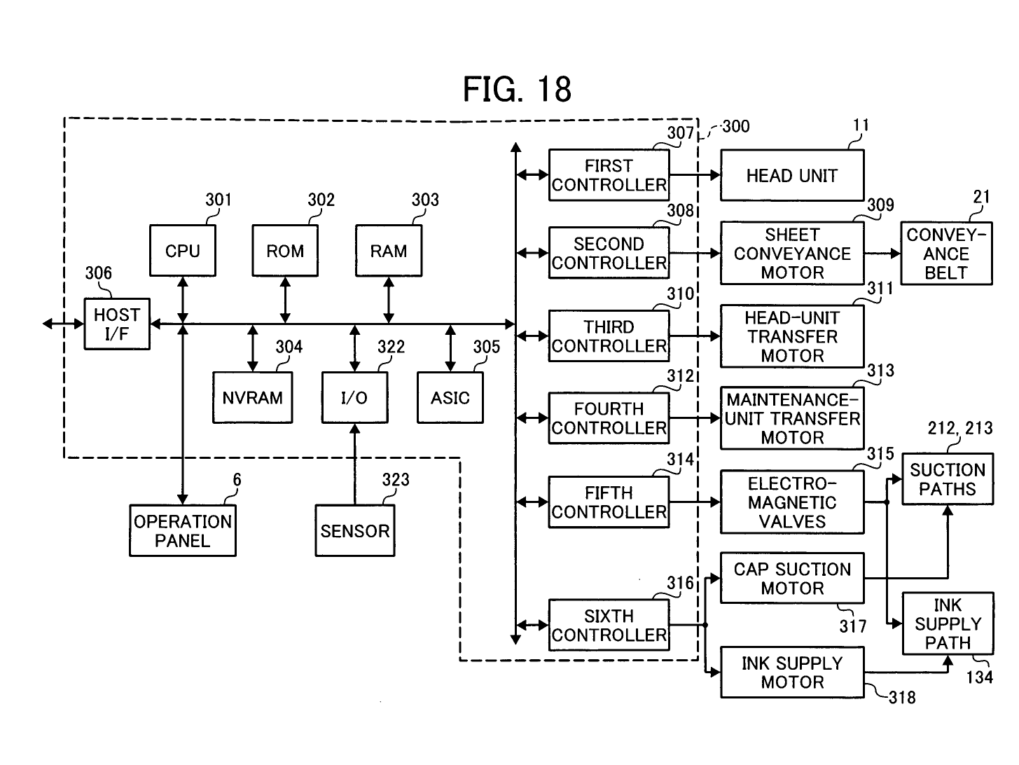

Next, a control unit of the image forming apparatus 1 is described with reference to FIG. 18.

FIG. 18 is a block diagram illustrating a control unit 300 of the image forming apparatus 1. In FIG. 18, the control unit 300 includes the CPU 301, a read only memory (ROM) 302, a random access memory (RAM) 303, a non-volatile random access memory (NVRAM) 304, and an application-specific integrated circuit (ASIC) 305. The CPU 301 serves as a controller to generally control the image forming apparatus 1. The ROM 302 stores programs to be executed by the CPU 301, an acceptable value for the contamination level of nozzle faces in an ink discharge operation, driving waveform data, or other fixed data. The RAM 303 temporarily stores image data or other data. The NVRAM 304 holds data even when the power of the image forming apparatus 1 is turned off. The ASIC 305 performs various signal processing on image data, image processing such as sorting, and input-and-output signal processing to entirely control the image forming apparatus 1.

The control unit 300 also includes a host interface (I/F) 306, a first controller 307, a second controller 308, a third controller 310, a fourth controller 312, a fifth controller 314, the sixth controller 316, and an input-and-output interface (I/O) 322.

The host I/F 306 is used to transmit and receive data and signals to and from host stations. The first controller 307 generates driving waveforms to drive and control pressure generators in each liquid discharge head 101. The second controller 308 drives a sheet conveyance motor 309. The third controller 310 drives a head-unit transfer motor 311. The fourth controller 312 drives a maintenance-unit transfer motor 313. The fifth controller 314 controls opening and closing operations of electromagnetic valves 315 including the valves 214 in the separate suction paths 212 and a valve in the ink supply path 134. The sixth controller 316 controls the driving of the cap suction motor 317 and the ink supply motor 318. The I/O interface 322 is used to input various detection signals which are output from an encoder in response to the travel amount and speed of the conveyance belt 21, from a sensor 323 capable of sensing ambient temperature and/or humidity, from the electrode sensor 141 capable of sensing the amount of ink stored in the subsidiary reservoir 14, and from various sensors which are not illustrated. An operation panel 6 serving as an operation-and-display unit is connected to the control unit 300.

With the host I/F 306, the control unit 300 receives print data through a cable or network from host stations, for example, an information processing apparatus including a personal computer, an image reading apparatus including an image scanner, and an image capturing apparatus including a digital camera.

The CPU 301 loads and analyzes such print data stored in a buffer of the host I/F 306 and causes the ASIC 305 to execute image processing, image sorting, or other appropriate processing on the image data. Thus, the image data, e.g., dot-pattern data corresponding to one page having a width identical to a width of the head unit 11 are transmitted to the first controller 307 in synchronization with a clock signal. To generate such dot-pattern data for image output, for example, font data stored in the ROM 302 may be used. Alternatively, after converting the image data into bit map data using a printer driver software of a host station, the bit map data may be transmitted to the image forming apparatus 1.

The first controller 307 drives each head 101 of the head unit 11 by selectively applying voltages to the pressure generators of the nozzles 102 based on the image data corresponding to one page of the head unit 11.

In this regard, such a liquid discharge head may be a piezoelectric head to discharge liquid droplets while deforming an electrically deformable element by applying voltages to the element, a thermal head to discharge liquid droplets while generating bubbles using heat obtained by applying a current to an electro-thermal converting element, and an electrostatic head to discharge liquid droplets using a mechanical restoring force of a diaphragm while deforming the diaphragm by electrostatic forces between the diaphragm and an electrode. The pressure generator or actuator to discharge liquid droplets is not limited to any one specific type and may be any suitable type. For example, the piezoelectric head can discharge different sizes of liquid droplets by adjusting driving waveforms to drive a piezoelectric element, thereby providing an image having excellent gradation. On the other hand, the thermal head is easy to obtain a highly integrated configuration and therefore is suitable for manufacturing a relatively great number of nozzles therein. Accordingly, the thermal head can provide a high-resolution image at a relatively high speed.

Alternatively, the liquid discharge head may be an edge shooter head in which a portion from a liquid channel to a discharging exit or nozzle has a linear shape, or a side shooter head in which the orientation of a liquid channel is different from that of a discharging exit.

The liquid used herein is not limited to ink and may be any suitable material that is in a liquid state at least within a range of thermally durable temperature of the head material. For example, the liquid may be a resist, DNA sample, or resin lens material according to its usage.

As a color material, the liquid may include a pigment, dye, or mixture thereof. The pigment is not limited to one specific type of pigment and may be any suitable organic or inorganic pigment although an organic pigment may be preferable in terms of specific gravity. Alternatively, a plurality of kinds of pigments may be mixed in the liquid. The particle diameter of such a pigment may preferably be from 0.01 μm to 0.30 μm. The particle diameter of 0.01 μm or less is closer to that of a dye and may have a disadvantage in light stability and/or feathering. Further, the particle diameter of 0.30 μm or more may cause clogging of a discharging exit or a filter, thereby resulting in an unstable discharge.

Further, the liquid may include an acidic, direct, basic, reactive, edible or any suitable dye having a desirable water or light stability. A plurality of kinds of dyes may be mixed in the liquid or with a pigment or other kinds of color material.

Such color materials may be added to the liquid unless effects of the present invention are reduced. In order to obtain a desirable performance for the liquid or prevent the nozzles of the recording head from being clogged due to drying, the liquid may further include a water-soluble organic solvent. Such a water-soluble solvent may also include a humectant and/or penetrant agent. For example, such a humectant agent is added to the liquid in order to prevent the nozzles of the recording head from being clogged due to drying. In this regard, a single kind of water-soluble solvent or a plurality of different kinds of water-soluble solvents may be included in a mixture with water.

A penetrant agent may be added to the liquid to enhance the wettability between the liquid and a recording medium and thus obtain a desired penetration speed of the liquid. Examples of such penetrant agents are polyoxyethylene alkyl phenylether surfactants, acetylene glycol surfactants, polyoxyethylene alkyl ether surfactants, and polyoxyethylene polyoxypropylene alkyl ether surfactants. Such compounds can reduce the surface tension of the liquid, thus increasing the wettability and the penetration speed.

The liquid may further include a preservative, fungicide, antirust agent, antioxidant, and/or pH adjuster. Such a preservative and/or fungicide can prevent fungus from growing, thereby enhancing image stability. Alternatively, an antirust agent can form a coating on a metal surface of the head or other component in contact with the liquid so as to prevent corrosion of the metal surface. Further, even if a radical species that may cause corrosion is generated in the liquid, an antioxidant can eliminate or reduce such radical species, thereby preventing corrosion.

The surface tension of the liquid is preferably 20 to 60 dyne/cm, further preferably 30 to 50 dyne/cm from the viewpoint of the compatibility between medium wettability and droplet particularization. The viscosity of the liquid is preferably 1.0 to 20.0 cP, further preferably 3.0 to 10.0 cP. The pH of the liquid is preferably 3 to 11, further preferably 6 to 10 from the viewpoint of preventing corrosion of a metal member contacting the liquid.

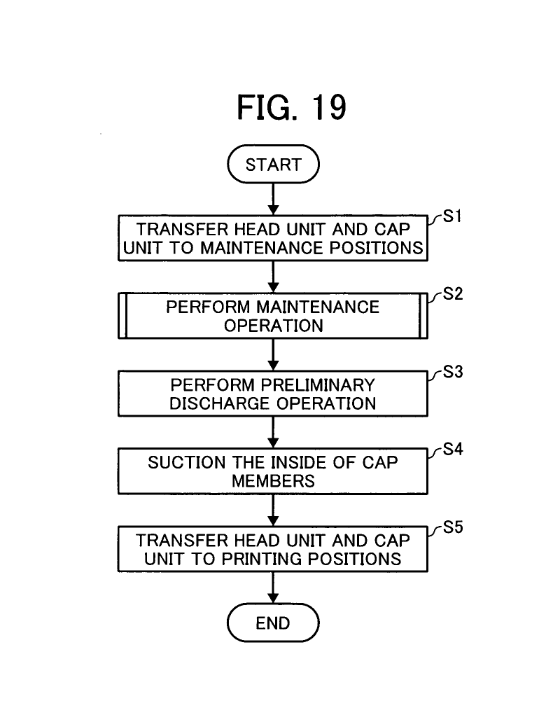

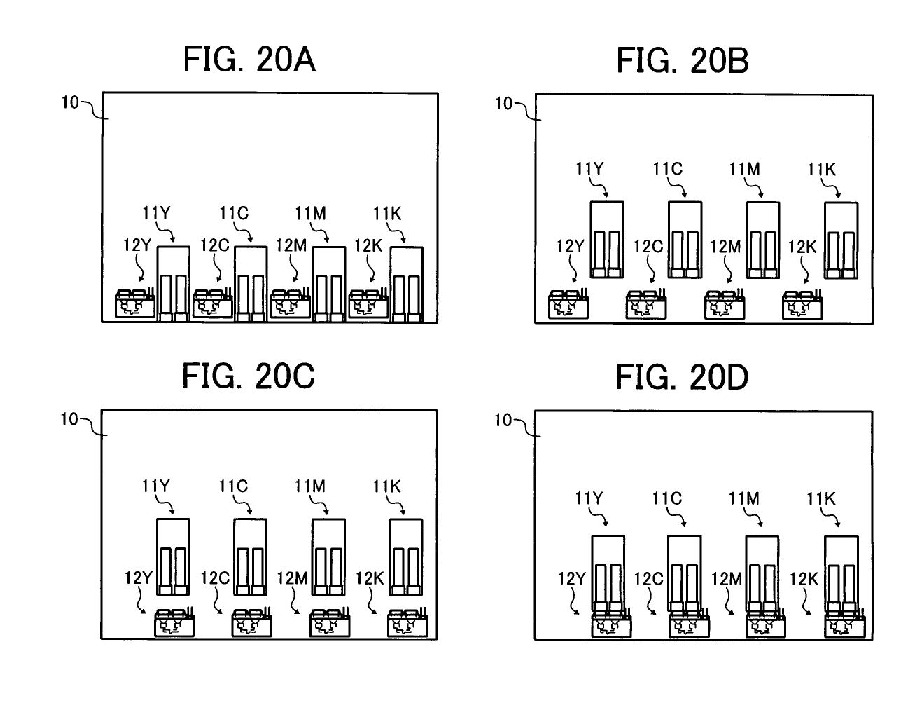

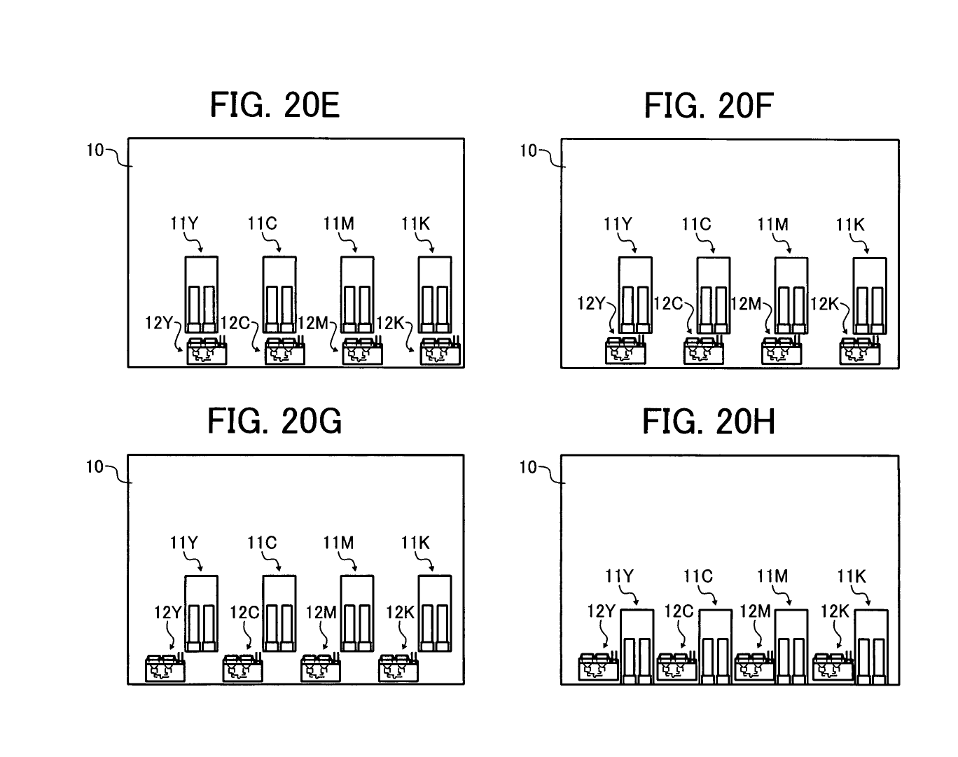

Next, a maintenance-and-recovery process of a liquid discharge head in the image forming apparatus is described with reference to a flow chart of FIG. 19 and schematic illustrations of FIGS. 20A to 20H.

Here, printing is performed in the image forming apparatus 1 illustrated in FIG. 4, and the head units 11 and the maintenance units 12 are disposed parallel to each other as illustrated in FIG. 5. In circumstances in which the head units 11 are positioned above a printing surface of a sheet, when the CPU 301 receives a request of a maintenance operation from the operation panel 6 or the host I/F 306 or when printing is continuously performed for a certain period of time, a maintenance operation process illustrated in FIGS. 20A to 20H is started.

When the maintenance operation process is started, at S1 of FIG. 19, the head units 11 and the maintenance units 12 are transferred to positions for maintenance. That is, the head units 11 are transferred upward from the printing positions as illustrated in FIG. 20A and are stopped at relatively high positions as illustrated in FIG. 20B. Meanwhile, the maintenance units 12 are transferred in a horizontal direction and are stopped at positions below the corresponding head units 11 as illustrated in FIG. 20C. When the head units 11 are transferred downward and are stopped at such positions as to closely contact the corresponding maintenance units 12 as illustrated in FIG. 20D, the nozzle faces 104 of the heads 101 of each head unit 11 are covered and sealed with the cap members 211 of each maintenance unit 12.

At S2 of FIG. 19, a maintenance operation is performed. In the maintenance operation, an ink ejection process is performed and then a wiping operation is performed for the nozzle faces 104 of the heads 101 of each head unit 11.

In the wiping operation, as illustrated in FIG. 20E, each head unit 11 is transferred upward and is stopped at a position lower than top faces of the wiping members 241 of the corresponding maintenance unit 12 by substantially 0.2 mm to 0.5 mm. As illustrated in FIG. 20F, each maintenance unit 12 is transferred in a horizontal direction so as to wipe the nozzle faces 104 of the heads 101 of each head unit 11. When the maintenance units 12 are stopped at printing positions as illustrated in FIG. 20G, the head units 11 are transferred directly upward and are stopped at positions as illustrated in FIG. 20B. The maintenance units 12 are transferred to the positions directly below the corresponding head units 11 as illustrated in FIG. 20C. The head units 11 are transferred downward to such positions as to closely contact the corresponding maintenance units 12 and return to the capped state illustrated in FIG. 20D.

At S3 of FIG. 19, a preliminary discharge operation is performed to eject ink from the heads 101 of each head unit 11 to the cap members 211. At S4 of FIG. 19, the suction pump 202 is started to drive so as to suction and remove the ejected ink.

At S5 of FIG. 19, the head units 11 and the maintenance units 12 are transferred to the respective printing positions. That is, as described above, the head units 11 are transferred directly upward and are stopped as illustrated in FIG. 20B, and the maintenance units 12 are transferred in a horizontal direction and are stopped at the respective printing positions as illustrated in FIG. 20G. The head units 11 are transferred downward and returned to the respective printing positions as illustrated in FIG. 20H.

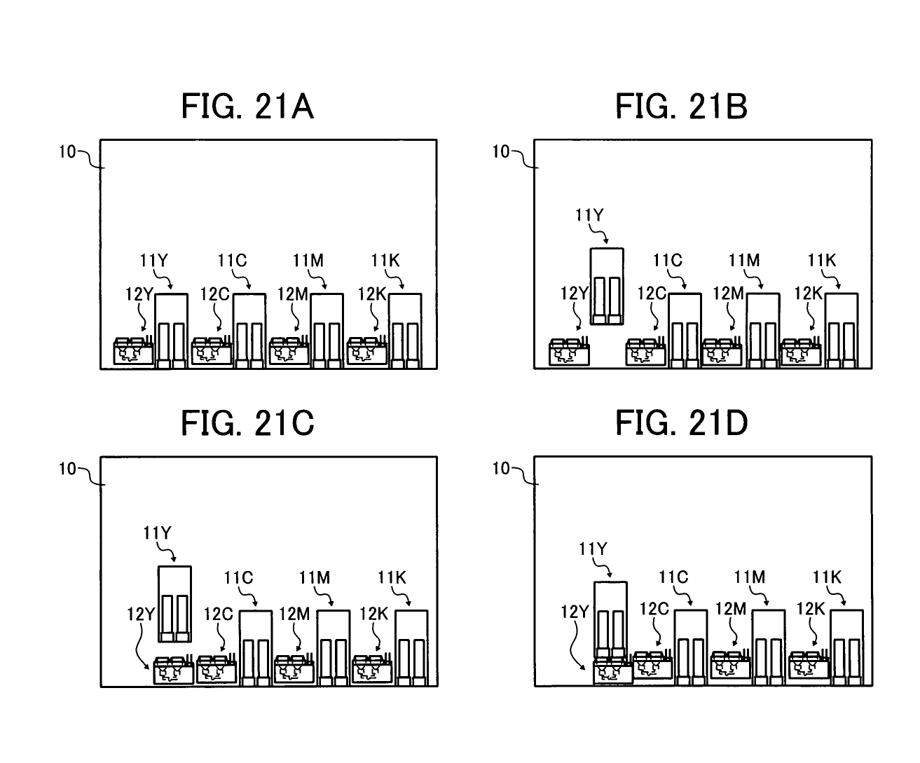

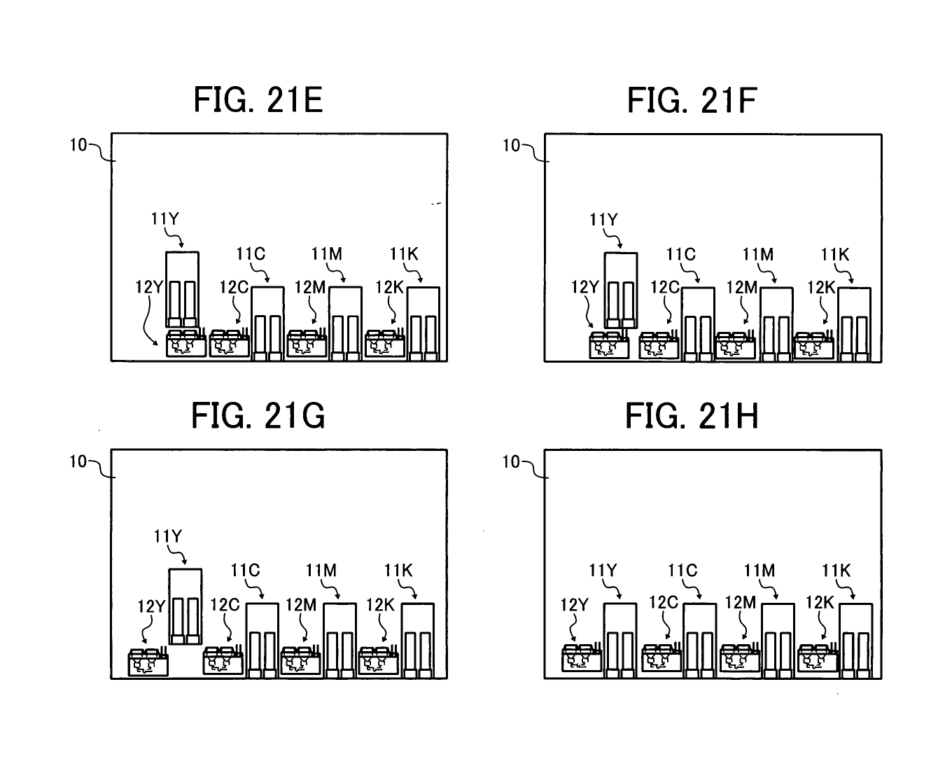

Next, another configuration of the relative movement between the head units 11 and the maintenance units 12 is described with reference to FIGS. 21A to 21H.

In this configuration, the head units 11 and the maintenance units 12 are movable independent of each other. In other words, the above-described maintenance operation can be performed on one head unit 11 (for example, a head unit 11Y as illustrated in FIGS. 21A to 21H) independent of the remaining head units 11. For the maintenance operation process after capping, the ink ejection process and wiping operation described above can be performed on one head unit 11, which is a target of the maintenance operation, independent of the remaining head units 11. In this regard, when the maintenance operation is performed on one head unit 11, the movement of the target head unit 11 and the corresponding maintenance unit 12 is substantially identical to the movement of each head unit 11 and the corresponding maintenance unit 12 described above with reference to FIGS. 20A to 20H, and therefore redundant descriptions are omitted herein.

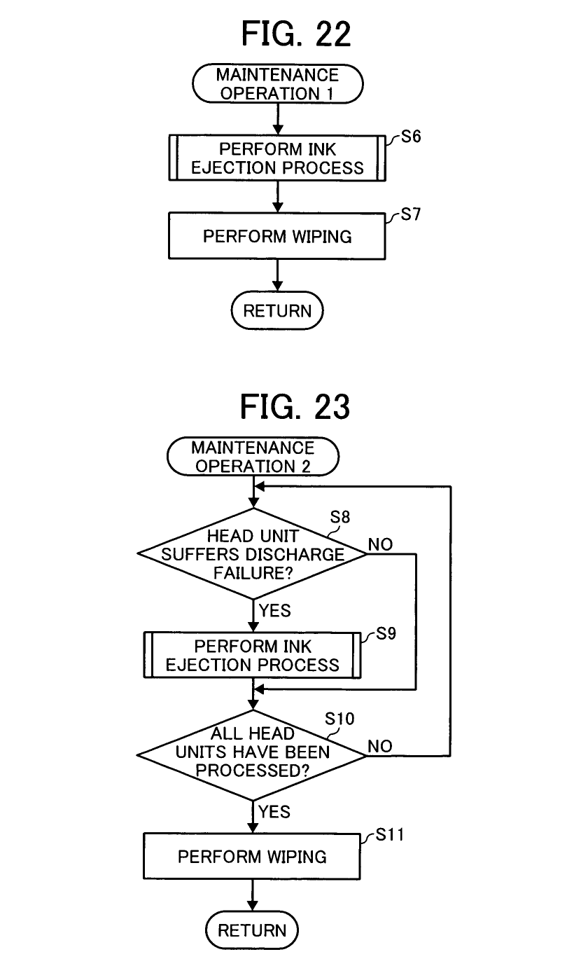

Next, other examples of the maintenance operation performed at S2 of FIG. 19 are described with reference to flow charts of FIGS. 22 to 24.

In the maintenance operation, the image forming apparatus 1 performs an ink ejection process described above to forcibly eject liquid (e.g., ink) from the nozzles 102 of a target head 101, and performs a wiping operation to wipe the nozzle face 104 with the wiping member(s) 241 of the wiper unit 204. Such an ink ejection process includes a first liquid ejection operation (hereinafter “first ejection mode”) to eject ink from the nozzles 102 at a first ejection amount and a second liquid ejection operation (hereinafter “second ejection mode”) to eject ink from the nozzles 102 at a second ejection amount, which is greater than the first ejection amount.

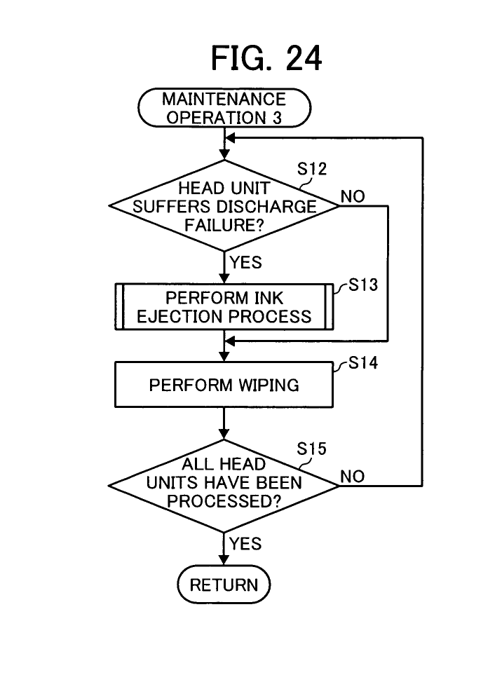

For the maintenance operation after the capping, the image forming apparatus 1 can perform the ink ejection process and wiping operation in a plurality of manners. For example, the image forming apparatus 1 may perform the ink ejection process and wiping operation on the head units all together as illustrated in FIG. 22. Alternatively, as illustrated in FIG. 23, the image forming apparatus 1 may perform the ink ejection process only on a head unit suffering a discharge failure and perform the wiping operation on all the head units. Further, as illustrated in FIG. 24, the image forming apparatus 1 may perform the ink ejection process and wiping operation only on a head unit suffering a discharge failure.

For example, in a maintenance operation 1 illustrated in FIG. 22, at S6, the image forming apparatus 1 performs the ink ejection process while the nozzle faces 104 of the head unit 11 is capped by the cap members 211 of the cap unit 201. At S7, the image forming apparatus 1 performs the wiping operation to wipe the nozzle faces 104 with the wiping member 241.

In a second maintenance operation 2 illustrated in FIG. 23, at S8, the image forming apparatus 1 determines whether or not a discharge failure is found in the head units 11Y, 11M, 11C, and 11K.

If one head unit suffers a discharge failure (“YES” at S8), at S9, the image forming apparatus 1 performs the ink ejection process on the failed head. Alternatively, if one head unit is in a normal state (“NO” at S8), the process goes to S10. At S10, it is determined whether or not all the head units 11 have been processed.

If all the head units have been processed (“YES” at S10), at S11, the wiping operation is performed and the maintenance operation 2 is finished.

In a maintenance operation 3 illustrated in FIG. 24, at S12, the image forming apparatus 1 determines whether or not a discharge failure is found in the head units 11Y, 11M, 11C, and 11K. If one head unit suffers a discharge failure, at S13, the image forming apparatus 1 performs the ink ejection process and, at S14, performs wiping operation. At S15, it is determined whether or not all the head units 11 have been processed. If all the head units 11 have been processed (“YES” at S15), the maintenance operation 3 is finished.

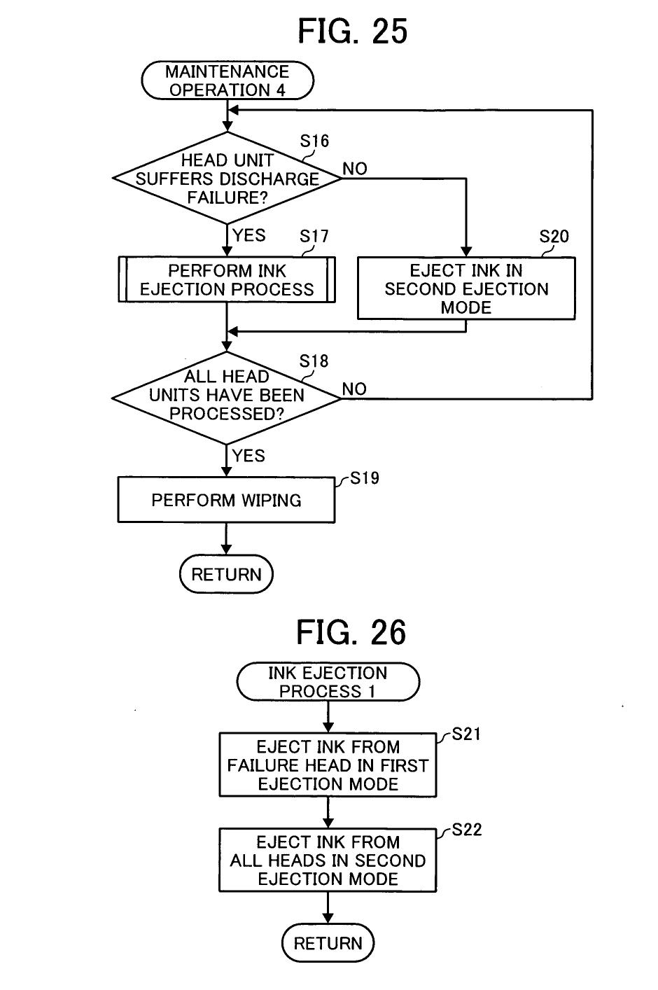

Next, a maintenance operation performed in an image forming apparatus 1 having a configuration of FIGS. 21A to 21H is described with reference to a flowchart of FIG. 25.

As described above, in the configuration of FIGS. 21A to 21H, the head units 11 and the maintenance units 12 are movable independent of each other. Accordingly, the image forming apparatus 1 can perform the above-described maintenance operations on only one head unit 11 selected as a maintenance target. Likewise, for the maintenance operation process after the capping, the image forming apparatus 1 can perform the ink ejection process and the wiping operation on only such a target head unit 11.

In a maintenance operation 4 illustrated in FIG. 25, at S16, the image forming apparatus 1 determines whether or not a discharge failure is found in the head units 11Y, 11M, 11C, and 11K.

If one head unit suffers a discharge failure (“YES” at S16), at S17, the image forming apparatus 1 performs the ink ejection process. Alternatively, if one head unit is in a normal state (“NO” at S16), the process goes to S20. At S20, the image forming apparatus 1 removes ink from the head unit in the second ejection mode.

At S18, the image forming apparatus 1 determines whether or not the process has finished for all the head units 11. If the process has finished (“YES” at S18), at S19, the image forming apparatus 1 performs the wiping operation and finishes the maintenance operation 4.

Next, several examples of the ink ejection process performed in the maintenance operations 1 to 4 illustrated in FIGS. 22 to 25 are described with reference to flowcharts of FIGS. 26 to 29.

The ink ejection process are performed according to the following methods, for example. Alternatively, the ink ejection process may be performed according to any suitable method if the control unit controls the first and second ejection modes during the maintenance operation to eject ink from the nozzles 102.

For example, in an ink ejection process 1 illustrated in FIG. 26, ink is ejected from a discharge failed head of a head unit in the first ejection mode, in which a relatively great amount of ink is ejected from nozzles. Then ink is ejected from all heads of the head unit in the second ejection mode, in which a relatively small amount of ink is ejected from nozzles.

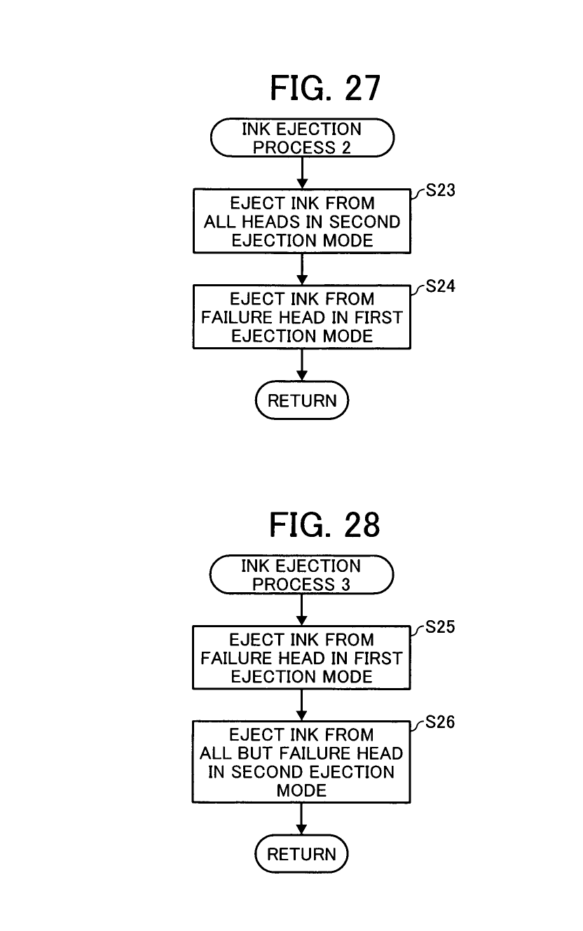

Alternatively, in an ink ejection process 2 illustrated in FIG. 27, ink is ejected from all heads of a head unit in the second ejection mode. Then, ink is ejected from a discharge failed head of the head unit in the first ejection mode.

In an ink ejection process 3 illustrated in FIG. 28, ink is ejected from a discharge failed head of a head unit in the first mode. Then, ink is ejected from all heads except the failed head of the head unit in the second ejection mode.

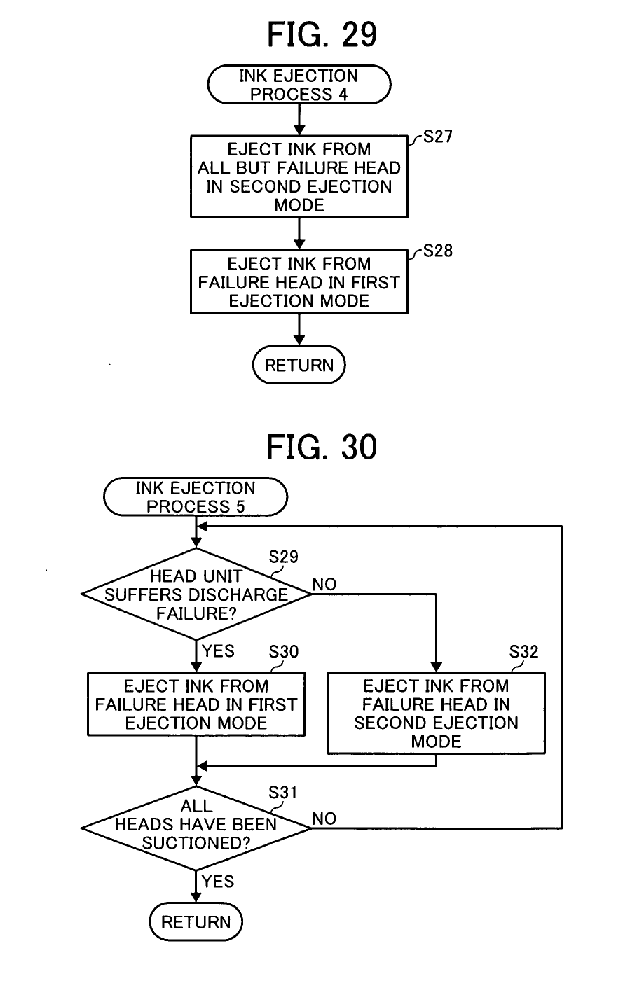

In an ink ejection process 4 illustrated in FIG. 29, ink is ejected from all heads except a discharge failed head of a head unit in the second ejection mode. Then, ink is ejected from the failed head of the head unit in the first ejection mode.

Any of the above-described ink ejection processes can be applied to the image forming apparatus 1.

For example, according to the ink ejection process 1 of FIG. 26, at S21, the image forming apparatus 1 removes ink from a discharge failed head among heads 101A to 101L of a head unit 11 in the first ejection mode. At S22, ink is ejected from all the heads 101A to 101L of the head unit 11 in the second ejection mode.

According to the ink ejection process 2 of FIG. 27, at S23, the image forming apparatus 1 removes ink from all heads 101A to 101L of a head unit 11 in the second ejection mode At S24, the image forming apparatus 1 removes ink from a discharge failed head among the heads 101A to 101L in the first mode.

According to the ink ejection process 3 of FIG. 28, at S25, the image forming apparatus 1 removes ink from a discharge failed head among heads 101A to 101L of a head unit 11 in the first ejection mode. At S26, the image forming apparatus 1 removes ink from all heads except the discharge failed head in the second ejection mode.

According to the ink ejection process 4 of FIG. 29, at S27, the image forming apparatus 1 removes ink from all heads except a discharge failed head among the heads 101A to 101L of a head unit 11 in the second ejection mode. At S28, the image forming apparatus 1 removes ink from the discharge failed head in the first ejection mode.

In this regard, the ejection amount of ink in the first ejection mode may preferably be 0.1 ml or more and 3 ml or less per head, more preferably 0.3 ml or more and 1 ml or less per head, although the amount is not limited to the above ranges. The greater the ejection amount of ink, the higher recovery performance can be obtained for such a discharge failed head. Meanwhile, an increase in the ejection amount of ink also increases the amount of waste ink, and therefore the above-described range may be preferable.

The ejection amount of ink in the second ejection mode is less than the ejection amount in the first ejection mode and typically 0.01 ml or more and 1 ml or less, preferably 0.01 ml or more and 0.5 ml or less. If the ejection amount in the second ejection mode were equal to or more than that of the first ejection mode, the effect of reducing the amount of waste liquid would not be obtained. Meanwhile, if no ink were further ejected to the nozzle face after the first ink ejection, some of ink ejected in the first ejection mode might be intruded into a nozzle or the slidability of the wiper unit might be reduced, thereby resulting in a poor recovery performance and/or degrading a nozzle face or wiper unit.

Next, other examples of the ink ejection process in the maintenance operation are described with reference to flowcharts of FIGS. 30 to 32.

In such examples, ink is ejected in turn from heads of a head unit according to the following methods, for example.

In one method illustrated in FIG. 30, it is determined whether or not each head of a head unit has a discharge failed nozzle. If one head has such a failed nozzle, ink is ejected from the failed head in the first ejection mode, in which a relatively great amount of ink is ejected from nozzles. Alternatively, if one head does not have such a failed nozzle or is in a normal state, ink is ejected from the normal head in the second ejection mode, in which a relatively small amount of ink is ejected from nozzles.

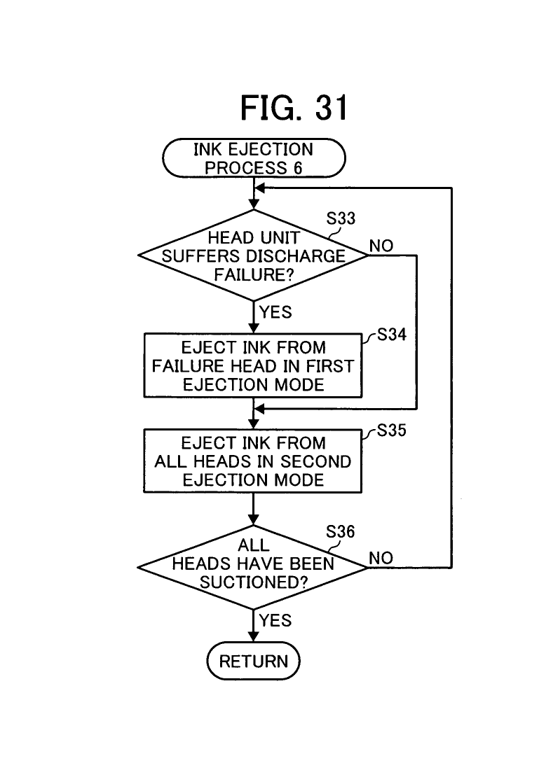

Alternatively, in one method illustrated in FIG. 31, it is determined whether or not each head of a head unit has a discharge failed nozzle. If one head has such a failed nozzle, ink is ejected from the failed head in the first ejection mode, and ink is ejected from all heads of the head unit in the second ejection mode.

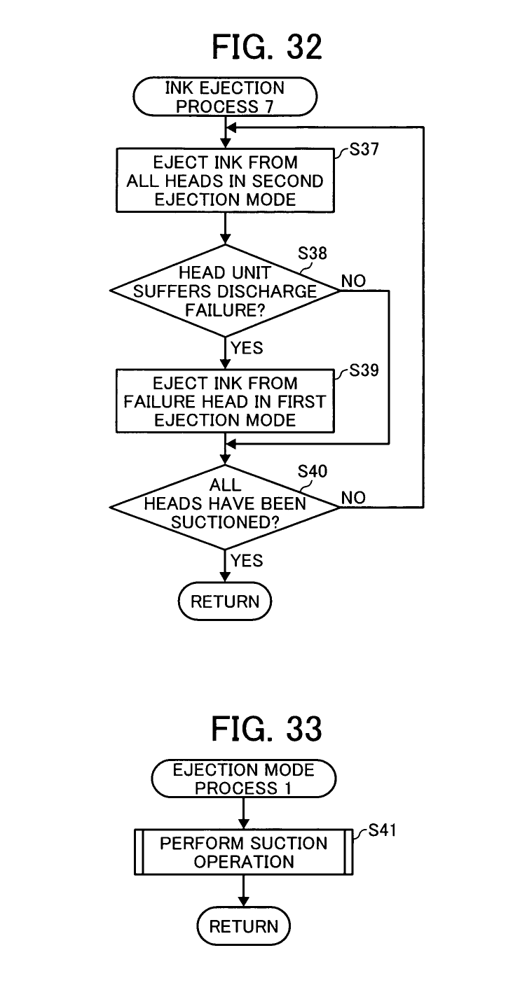

Further, in one method illustrated in FIG. 32, ink is ejected from all heads of a head unit in the second ejection mode. It is determined whether or not each head of the head unit has a discharge failed nozzle. If one head has such a failed nozzle, ink is ejected from the failed head in the first ejection mode.

Incidentally, using methods of the first and second ejection modes are not limited to the above-described methods, and the first and second ejection modes may be used at any appropriate timings in the ink ejection process.

In more detail, in an ink ejection process 5 illustrated in FIG. 30, at S29, it is determined whether or not each of heads 101A to 101L of a head unit 11 suffers a discharge failure.

If one head suffers a discharge failure (“YES” at S29), at S30, ink is ejected from the failed head in the first ejection mode and the process goes to S31. Alternatively, if one head is in a normal state (“NO” at S29), at S32, ink is ejected from the normal head in the second mode and the process goes to S31.

At S31, it is determined whether or not all the heads 101A to 101L of the head unit 1 have been suctioned. If all the heads have been suctioned (“YES” at S31), the ink ejection process 5 is finished.

In an ink ejection process 6 illustrated in FIG. 31, at S33, it is determined whether or not each of heads 101A to 101L of a head unit 11 suffers a discharge failure.

If one head suffers a discharge failure (“YES” at S33), at S34, ink is ejected from the failed head in the first ejection mode. At S35, ink is ejected in the second ejection mode and the process goes to S36. Alternatively, if one head is in a normal state (“NO” at S33), at S35, ink is ejected from the normal head in the second mode and the process goes to S36.

At S36, it is determined whether or not all the heads 101A to 101L have been suctioned. If all the heads have been suctioned (“YES” at S36), the ink ejection process 6 is finished.

In an ink ejection process 7 illustrated in FIG. 32, at S37, ink is ejected from all heads 101A to 101L of a head unit 11 in the second ejection mode.

At S38, it is determined whether or not each of the heads 101A to 1011 suffers a discharge failure. If one head suffers a discharge failure (“YES” at S38), at S39, ink is ejected from the failed head in the first ejection mode and the process goes to S40. Alternatively, if one head is in a normal state (“NO” at S38), the process goes to S40.

At S40, it is determined whether or not all the head units 101A to 101L have been suctioned. If all the heads have been suctioned (“YES” at S40), the ink ejection process 7 is finished.

As described above, when dealing with the respective heads of the head unit one by one, it may take a relatively long time to perform the maintenance operation. On the other hand, the above-described methods can reduce the capacity of suction pump, thereby facilitating the size and cost reduction of the image forming apparatus 1.

Next, a process (hereinafter “ejection mode process”) to eject ink in the above-described ink ejection process 1 to 7 is described in a flowchart of FIG. 33.

In an ejection mode process 1 of FIG. 33, as described above, the suction pump 202 is driven while the nozzle faces of the heads 101 are capped with the cap members 211, which serve as the suction sections of the cap unit 201. As a result, negative pressures are generated inside the cap members 211 so that ink is ejected from the nozzle faces 104 of the heads 101 to the cam members 211. Thus, at S41 of FIG. 33, a suction operation is performed.

Regarding the ejection mode process 1, the suction amount of the ink is set to a relatively large value when ink is ejected in the first ejection mode in the ink ejection process, while the suction amount of ink is set to a relatively small value when ink is ejected in the second ejection mode. Thus, the suction operation can be performed in accordance with the first ejection mode in which a relatively large amount of ink is ejected and the second ejection mode in which a relatively small amount of ink is ejected, thereby preventing a maintenance failure in the wiping operation as described later.

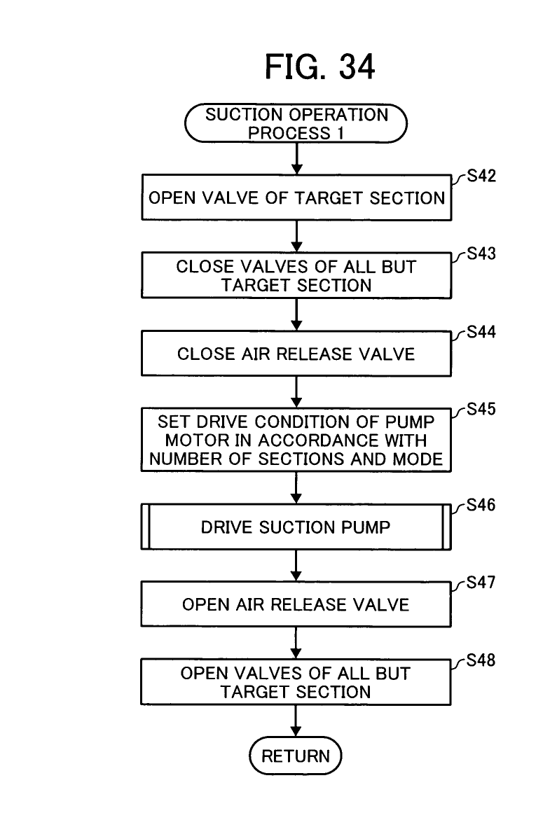

Next, a suction operation process performed in the ejection mode process 1 is described with reference to a flowchart of FIG. 34.

In a suction operation process 1 of FIG. 34, at S42, a target valve 214 corresponding to a target suction section or cap member 211 of the cap unit 201 is opened. At S43, all valves 214 except the target valve 214 are closed, and at S44 the air release valve 216 of the common suction path 213 is closed.

At S45, the drive condition of the suction pump 202 is set based on a setting value calculated from a suction amount defined in accordance with the number of suction sections and mode. At S46, the suction pump 202 is driven under the drive condition.

At S47, the air release valve 216 of the common suction path 213 is opened and at S48 the valves 214 other than the target valve 214 are opened. Thus, the suction operation process 1 is finished.

As described above, by opening the air release valve 216 of the common suction path 213, a resistance generated in separating the cap members 211 from the nozzle faces 104 of the heads 101 can be reduced, thereby suppressing an unexpected ink ejection due to a negative pressure that might occur in the separation of the cap members 211 from the nozzle faces 104.

As described above, the valves are provided corresponding to the respective suction sections so that the suction operation can be separately performed on the respective heads. Thus, such a configuration can enhance the suction efficiency and recovery performance of the maintenance operation. Further, such a configuration can enhance a maintenance performance without complicating the configuration of the head unit.

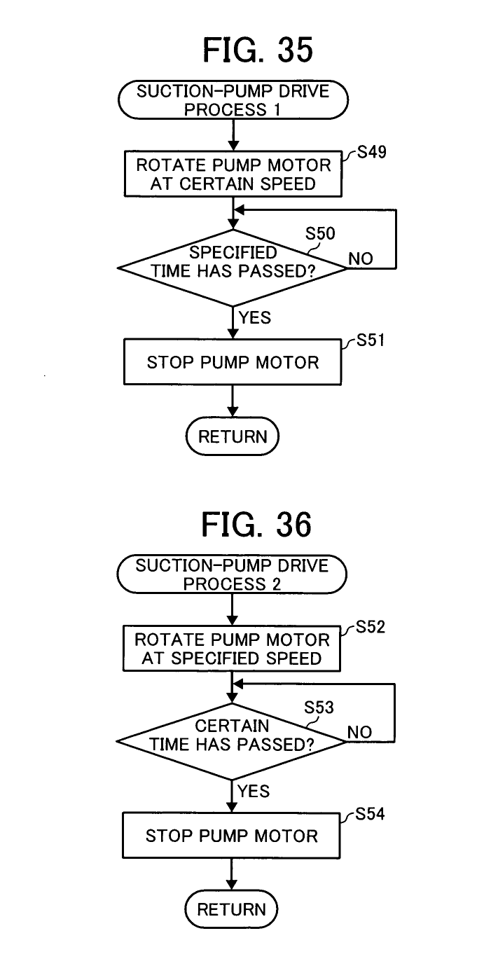

Next, other examples of the suction-pump drive process performed in the suction operation process 1 are described with reference to flowcharts of FIGS. 35 to 37.

The drive condition of the suction pump 202 used in suctioning the inside of the cap members 211 may be changed depending on the characteristic or performance of the cap suction motor 317 that rotationally drives the suction pump 202.

For example, when the cap suction motor 317 has a relatively low flexibility in the variable amount of rotation speed, the driving time may be used as a control factor. In such a case, as illustrated in the suction-pump drive process 1 of FIG. 35, at S49, the cap suction motor 317 of the suction pump 202 is rotated at a certain speed or rpm (rotations per minute). When a specified driving time has passed (“YES” at S50), at S51, a control operation is performed to stop the rotation of the motor 317.

Alternatively, when the cap suction motor 317 has a relatively great flexibility in the variable amount of rotation speed, the rotation speed may be used as a control factor. In such a case, as illustrated in a suction-pump drive process 2 of FIG. 36, at S52, the cap suction motor 317 of the suction pump 202 is rotated at a specified speed and. When a certain driving time has passed (“YES” at S53), at S54, a control operation is performed to stop the rotation of the motor 317.

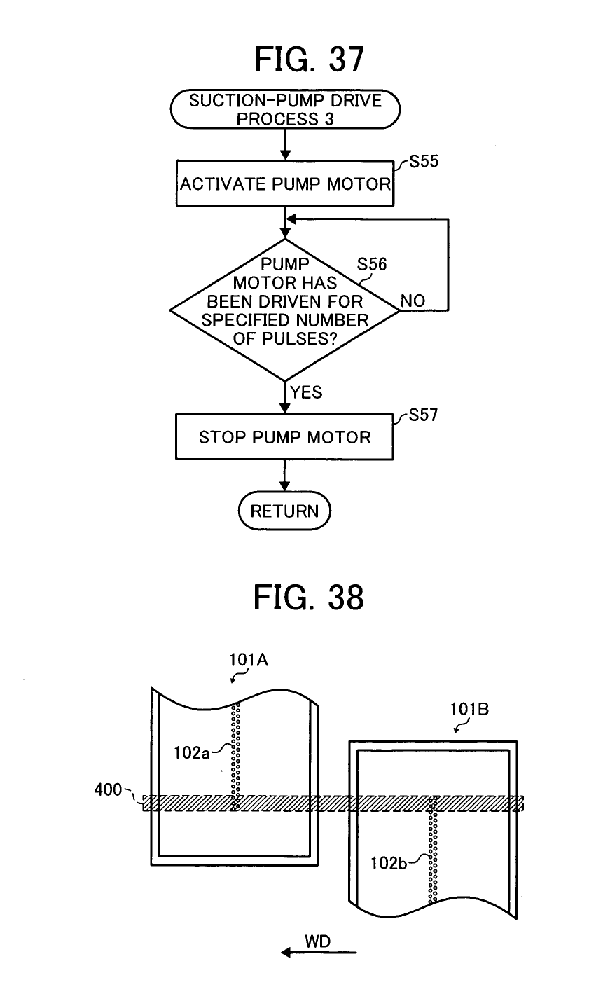

Further, when the cap suction motor 317 is a pulse motor capable of precisely controlling its rotation speed, the number of pulse may be used as a control factor. In such a case, as illustrated in a suction-pump drive process 3 of FIG. 37, at S55, the motor 317 of the suction pump 202 is activated. At S56, it is determined whether or not the motor 317 has been driven for a specified number of pulse. If the motor 317 has been driven for the specified number of pulse (“YES” at S56), at S57, a control operation is performed to stop the rotation of the motor 317.

Incidentally, the suction-pump drive processes 1 to 3 can be applied to the driving of a suction pump according to any of the exemplary embodiments described later. Therefore, redundant descriptions are omitted below for the sake of simplicity.

As described above, the image forming apparatus 1 according to the first exemplary embodiment includes a control unit to perform a first liquid ejection operation (first ejection mode) to eject a first ejection amount of ink from a head and a second liquid ejection operation (second ejection mode) to eject a second amount of ink, which is smaller than the first ejection amount of ink, by appropriately controlling a suction pump during the maintenance operation. Thus, as illustrated in FIGS. 26 and 32, the image forming apparatus 1 ejects ink from a discharge failed head in the first ejection mode and also ejects ink from a normal head in the second ejection mode.

With such a configuration, even if one discharge failed head and one normal head overlap in the wiping direction WD of the wiper unit, the image forming apparatus 1 can prevent a portion of waste liquid wiped by a wiping member from intruding into a nozzle of the normal head, thereby preventing the normal head from suffering a discharge failure due to the maintenance operation.

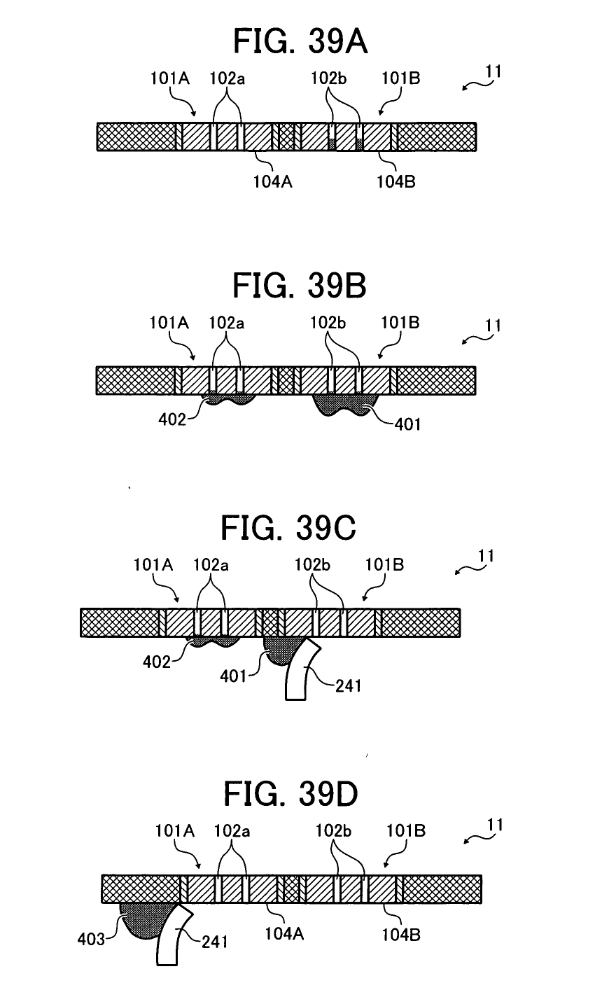

In this regard, a further description is provided with reference to FIGS. 38 and 39A to 39D. As illustrated in FIG. 38, for example, a head 101A and a head 101B of a head unit 11 have an overlapping area 400 in a wiping direction WD of a wiping member 241.

In such a configuration, if nozzles 102a of the head 101A are in a normal state while nozzles 102b of the head 101B suffer discharge failures as illustrated in FIG. 39A, the image forming apparatus 1 ejects ink from the nozzles 102b at the first ejection amount and from the nozzles 102a at the second ejection amount, which is smaller than the first ejection amount. As a result, residual inks 401 and 402 may appear on respective nozzle faces 104B and 104A of the head 101B and the head 101A as illustrated in FIG. 39B.

When a wiping operation is performed as illustrated in FIG. 39C, the wiping member 241 wipes the residual ink 401 from the nozzle face 104B of the head 101B while moving toward the nozzle face 104A of the head 101A. The wiping member 241 also wipes the residual ink 402 on the nozzle face 104A of the head 101A and moves away from the head unit 11 while wiping the residual inks 401 and 402 together as a waste ink 403.

In this regard, before wiping, ink is ejected from the nozzles 102a to the nozzle face 104A of the normal head 101A as well as from the nozzles 102b to the nozzle face 104B of the failed head 101B. Therefore, even when the wiping member 241 wipes the nozzle face 104A of the head 101A while dragging the residual ink 401 of the nozzle face 104B of the head 101B, the intrusion of the residual ink 401 into the nozzles 102a can be prevented.

Thus, the discharge failed nozzles 102b of the head 101B can be recovered into a normal state without causing a discharge failure in the normal head 101A. Further, such an ink ejection process can reduce the ejection amount of ink compared to an ink ejection process in which ink is ejected from all heads at an identical ejection amount.

As a result, this ejection process can reduce the amount of waste liquid in the maintenance operation and maintain a line-type head unit having a number of nozzles in a desirable status regarding the discharge reliability.

As described above, the image forming apparatus 1 includes at lease one head unit, cap unit, suction device, and wiper unit. Each head unit includes a plurality of liquid discharge heads. Each of the liquid discharge heads has a nozzle face on which a plurality of nozzles to discharge liquid droplets are arranged. The liquid discharge heads are arranged on the head unit in a direction parallel to a direction in which the nozzles are arranged. The cap unit caps the nozzle faces of the liquid discharge heads of each head unit. The suction device suctions the inside of the cap unit while the nozzle faces of the heads are capped with the cap unit. The wiper unit wipes the nozzle faces of the liquid discharge heads.

The image forming apparatus 1 further includes a control unit to control a first ejection operation to eject liquid from a discharge failed head at a first ejection amount and a second ejection operation to eject liquid from a normal head at a second ejection amount, which is smaller than the first amount. Such a configuration can prevent waste liquid wiped by the wiper unit from intruding into a normal nozzle and causing a discharge failure in the normal nozzle. Thus, a maintenance failure due to the wiping operation can be prevented while reducing the amount of waste liquid.

In such a configuration, both the first and second ejection operations may be performed on a discharge failed head, thereby facilitating the maintenance operation. Alternatively, only the second ejection operation may be performed on a normal head so as to reduce the amount of waste liquid.

Further, the maintenance operation including the first ejection operation may be performed only on a discharge failed head so as to reduce the amount of waste liquid.

The cap unit is provided with suction sections corresponding to the respective liquid discharge heads. Such a configuration allows the image forming apparatus 1 to perform the suction operation only on a discharge failed head, thereby reducing the amount of waste liquid. In such a case, the image forming apparatus 1 may include a plurality of suction devices to separately suction the respective suction sections of the cap unit, thereby reducing the amount of waste liquid.

Further, the image forming apparatus 1 may include a common suction device for the plurality of suction sections and a plurality of valves intervening between the common suction device and each of the suction sections of the cap unit. Such a configuration allows the image forming apparatus 1 to separately suction the suction sections by the common suction device.

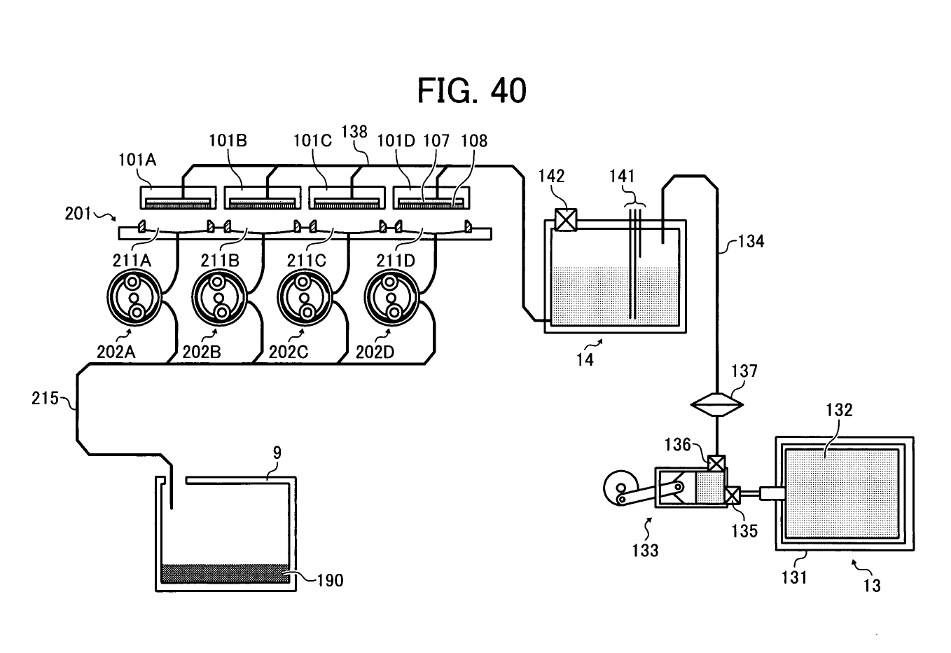

Next, a second exemplary embodiment is described with reference to FIG. 40. FIG. 40 is a schematic view illustrating an ink path of an image forming apparatus according to the second exemplary embodiment.

In FIG. 40, suction pumps 202A to 202D are disposed in the separate suction paths instead of the valves 214 provided corresponding to the respective suction sections or cap members 211 of the cap unit 201 illustrated in FIG. 15. The configuration of FIG. 40 does not include the suction pump 202 provided to the common suction path 213 of FIG. 15. The suction pumps 202A to 202D are preferably capable of performing both the suction and pressure-release operations illustrated in FIGS. 17A and 17B. Other configuration is substantially identical to that of the first exemplary embodiment and therefore redundant descriptions are omitted for the sake of simplicity.

A maintenance operation of the second exemplary embodiment may be identical to any of the maintenance operations 1 to 4 of the first exemplary embodiment illustrated in FIGS. 22 to 25. An ink ejection process of the second exemplary embodiment may be identical to any of the ink ejection processes 1 to 7 of the first exemplary embodiment illustrated in FIGS. 26 to 32. An ejection mode process in the ink ejection process of the second exemplary embodiment may be identical to the ejection mode process 1 of the first exemplary embodiment illustrated in FIG. 33. In such a case, ink is ejected from nozzles 102 of a head 101 by performing a suction operation on each suction section.

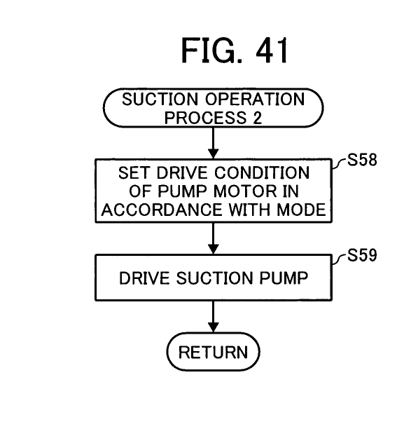

In this regard, a suction operation process performed in the ejection mode process 1 of the second exemplary embodiment is described with reference to a flowchart of FIG. 41.

In a suction operation process 2 of FIG. 41, at S58, the drive conditions of respective motors to drive the suction pumps 202A to 202D are set based on the suction amounts of ink, which are determined in accordance with the ejection modes. At S59, the respective motors are controlled according to the drive conditions so as to drive the suction pumps 202A to 202D.

In a case where a tubing pump capable of performing a pressure-release operation as illustrated in FIGS. 17A and 17B is used as the suction pump 202, after the suctioning, each suction pump 202 is rotated in a reverse direction so as to release a suction pressure. With this releasing, the internal pressure of a cap member 211 is preferably returned to atmospheric pressure. Alternatively, in a case where a tubing pump as illustrated in FIG. 16 is used as the suction pump 202, when the head unit 11 is separated from the cap members 201, the suction pumps 202 are rotated in a direction opposite a suction direction. As a result, a slight positive pressure can be generated in the cap members 211, thus reducing a resistance in the separation.

In the second exemplary embodiment, the image forming apparatus may also employ any of the ink ejection processes 1 to 7 illustrated in FIGS. 26 to 32. As described above, in the ink ejection processes 1 to 7, the first ejection mode is set to eject a relatively large amount of ink while the second ejection mode is set to eject a relatively small amount of ink. Thus, a maintenance failure that might occur in a wiping operation can be prevented while reducing the amount of waste liquid generated in the maintenance operation.

According to the second exemplary embodiment, a simple configuration can be obtained with a relatively small number of valves. Further, the suction pumps are connected to the respective cap members, enabling a fine tuning of the suction force while reducing the power of each suction pump.

As described above, the cap unit is provided with the suction sections corresponding to the respective liquid discharge heads. Further more, the plurality of suction devices (e.g., pumps) are provided corresponding to the respective suction sections of the cap unit. Thus, the suction sections of the cap unit are separately suctioned by the respective suction devices, allowing the suction sections to be suctioned with different suction forces.

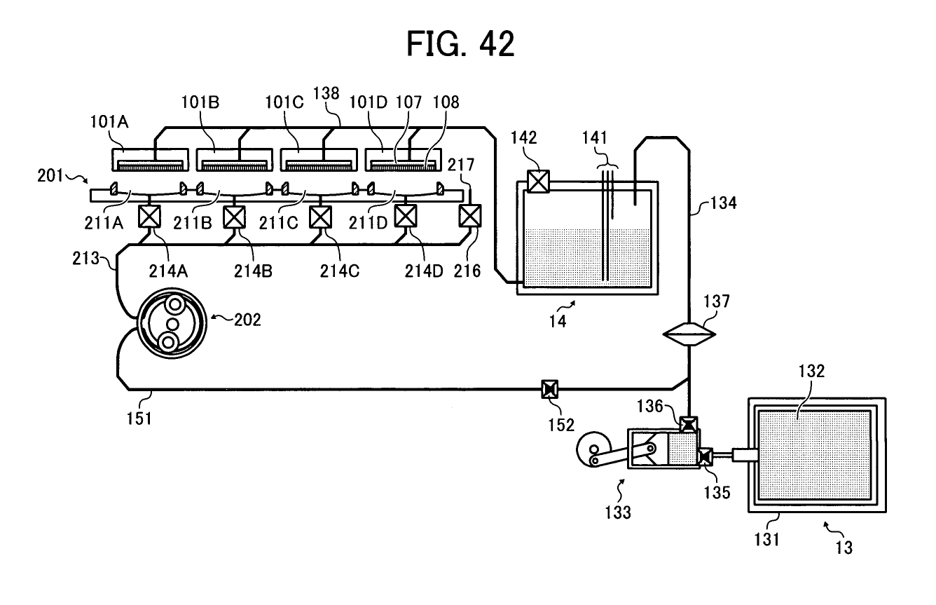

Next, a third exemplary embodiment is described with reference to FIG. 42. FIG. 42 is a schematic view illustrating an ink path according to the third exemplary embodiment.

In FIG. 42, the ejection side of the suction pump 202 is connected via a circulation path 151 to a portion between a supply pump 133 and a filter 137 of an ink supply path 134. The circulation path 151 has a check valve 152. Other configuration is substantially identical to that of the first exemplary embodiment and therefore redundant descriptions are omitted for the sake of simplicity.

A maintenance operation performed in the third exemplary embodiment may be identical to any of the maintenance operations 1 to 4 of the first exemplary embodiment illustrated in FIGS. 22 to 25. An ink ejection process of the third exemplary embodiment may be identical to any of the ink ejection processes 1 to 7 of the first exemplary embodiment illustrated in FIGS. 26 to 32. An ejection mode process in the ink ejection process of the third exemplary embodiment may be identical to the ejection mode process 1 of the first exemplary embodiment illustrated in FIG. 33. In such a case, ink is suctioned and ejected from nozzles 102 of each head 101 by performing a suction operation on each suction section.

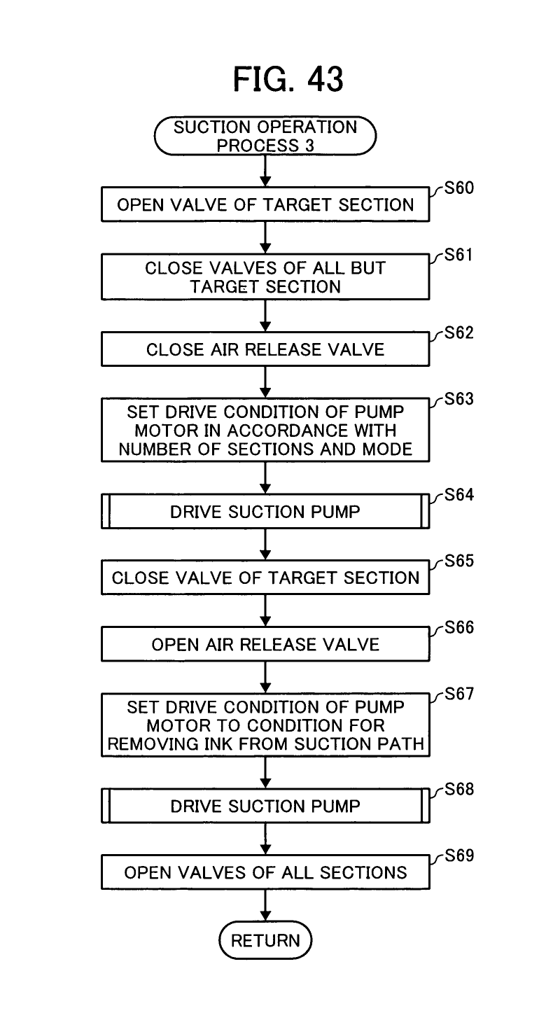

In this regard, a suction operation process performed in the ejection mode process 1 of the third exemplary embodiment is described with reference to a flowchart of FIG. 43.

In a suction operation process 2 of FIG. 43, at S60, a valve 214 corresponding to a target suction section or cap member 211 is opened. At S61, other valves 214 corresponding to all suction sections except the target section are closed. At S62, an air release valve 216 of a common suction path 213 is closed.

At S63, the drive condition of a motor to drive the suction pump 202 is set based on a suction amount defined in accordance with the number of suction sections and the suction mode. At S64, the suction pump 202 is driven under the drive condition.

At S65, the valve 214 corresponding to the target suction section is closed. At S66, the air release valve 216 of the common suction path 213 is opened. At S67, the drive condition of the motor of the suction pump 202 is set to a condition for removing ink from the suction path.

At S68, the motor is controlled according to the drive condition to drive the suction pump. At S69, the valves 214 corresponding to all suction sections are opened.

Thus, a resistance that may be generated in separating the cap members 211 from the heads 101 can be suppressed, thereby preventing an unintentional ink ejection due to a negative pressure that might be generated by the resistance. Further, such ejection of ink from the suction path can reduce a variation in suction condition, for example, a variation in pressure between suction operations.

In the third exemplary embodiment, the image forming apparatus may also employ any of the ink ejection process 1 to 7 illustrated in FIGS. 26 to 32. As described above, in the ink ejection processes 1 to 7, the first ejection mode is set to eject a relatively large amount of ink while the second ejection mode is set to eject a relatively small amount of ink. Thus, a maintenance failure that might occur in a wiping operation can be prevented while reducing the amount of waste liquid generated in the maintenance operation.

Further, in this configuration, the waste liquid received in the cap members is forwarded through the circulation path 151 and filtered by the filter 137 for reuse, thus suppressing the amount of the waste liquid.

Next, a fourth exemplary embodiment is described with reference to FIG. 41. FIG. 41 is a schematic view illustrating an ink path according to the fourth exemplary embodiment.

In this configuration, a feed pump 153 is provided to pump ink stored in a subsidiary reservoir 14 to a head unit 11. When ink is fed by the feed pump 153 through an ink supply path 138 to a head 101D, the ink is further sent into one end portion of a common chamber 107D of the head 101D and is sent out from another end portion of the common chamber 107D. Similarly, the ink is sequentially sent through common chambers 107C, 107B, and 107A. When the ink is sent out from one end portion of the common chamber 107A, the ink is sent back to the subsidiary reservoir 14 via an ink return valve 155 through a return path 154. Other configuration is substantially identical to that of the first exemplary embodiment and therefore redundant descriptions are omitted for the sake of simplicity.

A maintenance operation performed in the fourth exemplary embodiment may be identical to any of the maintenance operations 1 to 4 of the first exemplary embodiment illustrated in FIGS. 22 to 25. In the maintenance operation, an ink ejection process is performed before a wiping operation. The ink ejection process of the fourth exemplary embodiment may be identical to any of the ink ejection processes 1 to 7 of the first exemplary embodiment illustrated in FIGS. 26 to 32.

In this regard, an ejection mode process performed in the ink ejection process is described below with reference to a flowchart of FIG. 42.

In an ejection mode process 2 of FIG. 42, at S70, a supply-operation start process is performed to supply ink to heads 101. At S71, a suction operation process is performed to eject ink from the heads 101 via the cap members 211. At S72, a supply-operation stop process is performed to stop supplying ink to the heads 101.

In the ejection mode process 2, for example, a supply-operation start process 1 illustrated in FIG. 43 is performed as the supply-operation start process. In the supply-operation start process 1, at S73, the drive condition of the motor of the feed pump 153 is set in accordance with the ink ejection mode. In other words, the driving condition is set to a condition in which, while an ink return valve 155 is open, the feed pump 153 can feed a larger amount of ink than an amount of ink ejected in the ink ejection process. Under such a condition, at S74, the feed pump 153 is activated to start feeding ink. When the ink feeding is started, ink is fed from the subsidiary reservoir 14 to the head 101. Excess ink is sent from a return side of the heads 101 through the return path 154 back to the subsidiary reservoir 14.

In such a circulating configuration, the suction operation process 3 illustrated in FIG. 43 is performed as a suction operation process in the fourth exemplary embodiment.

As described above, In the suction operation process 3, at S60, a valve 214 corresponding to a target suction section or cap member 211 is opened. At S61, other valves 214 corresponding to all suction sections except the target section are closed. At S62, an air release valve 216 of a common suction path 213 is closed. At S63, the drive condition of a motor to drive the suction pump 202 is set based on a setting value obtained from a suction amount corresponding to an ejection amount of the ejection mode. At S64, the suction pump 202 is driven under the drive condition to perform a suction operation.

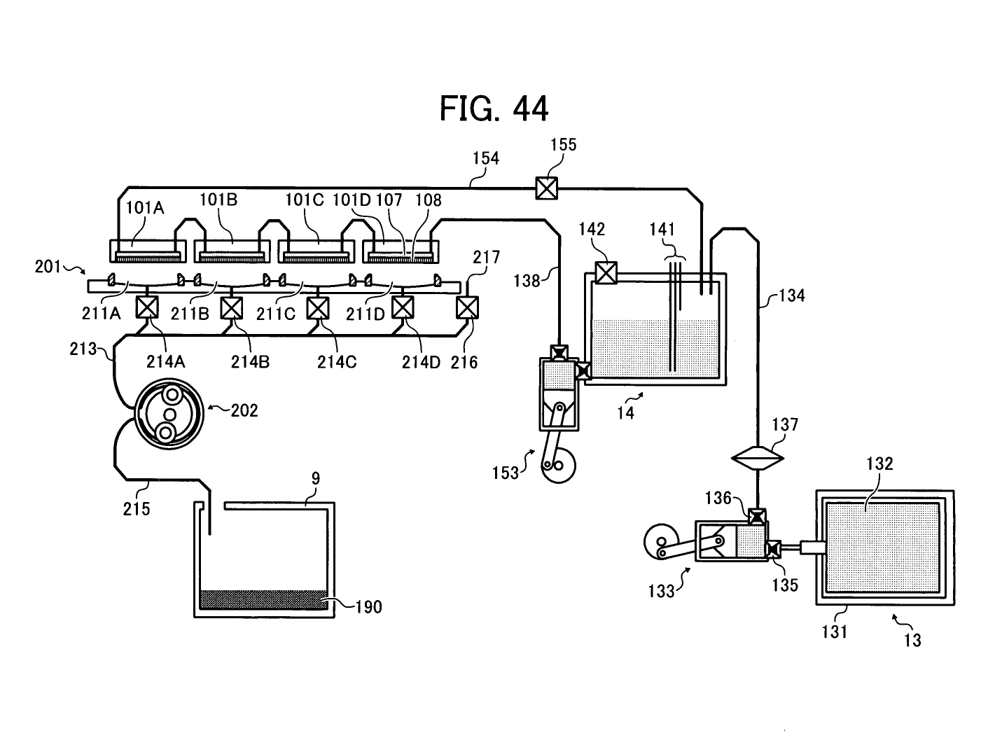

After the suction operation, at S75, a supply-operation stop process 1 illustrated in FIG. 44 is performed to stop feeding ink. Further, the air release valve 216 is opened to return the suction path into atmospheric pressure. Thus, residual ink in the suction path is removed and all the valves 214 of the suction sections are opened.

Thus, a resistance that may be generated in separating the cap members 211 from the heads 101 can be suppressed, thereby preventing an unintentional ink ejection due to a negative pressure that might be generated by the resistance. Further, such an ejection of ink from the suction path can reduce a variation in suction condition, for example, a variation in pressure in suction operations. Further, when the ejection mode process illustrated in FIG. 30 is performed to suction the respective heads in turn, such ink ejection can also suppress a variation in suction performance between the heads, thereby providing a stable recovery performance from a discharge failure.

When a target head is suctioned in the maintenance operation, a variation in the internal pressure of the ink supply path may be caused, thereby affecting an adjacent head of the target head. For example, suctioning a target head may generate a negative pressure in an adjacent head, thereby applying a pressure to a meniscus of a nozzle in a direction toward the center of the adjacent head. If the pressure were high, the meniscus would move backward so as to suck air, resulting in a discharge failure in the nozzle.

Hence, in the fourth exemplary embodiment, ink is circulated during the suction operation so that a sufficient amount of ink is supplied to the heads. Thus, such a factor that may cause a discharge failure as described above can be precluded so as to enhance the reliability of the maintenance operation. Further, the suction operation can be performed with less consideration for the influence to the adjacent head.

In the fourth exemplary embodiment as well, the suction amount in the first ejection mode is set to a relatively large amount while the suction amount in the second ejection mode is set to a relatively small amount. With the ejection modes, one of the above-described ink ejection processes 1 to 7 illustrated in FIGS. 26 to 32 is performed and thus a maintenance failure in the wiping operation can be suppressed.

In the fourth exemplary embodiment, in consideration of advantages of the first exemplary embodiment, the suction and recovery operations are performed by using the ink circulation between the heads 101 and the subsidiary reservoirs 14, thus enhancing the reliability of the maintenance operation and the recovery performance.

Next, a fifth exemplary embodiment is described with reference to FIGS. 48 to 53 and additionally FIG. 44 described above.

The configuration of an ink path of the fifth exemplary embodiment is substantially identical to that of the fourth exemplary embodiment illustrated in FIG. 44. Therefore, redundant descriptions are omitted for the sake of simplicity.

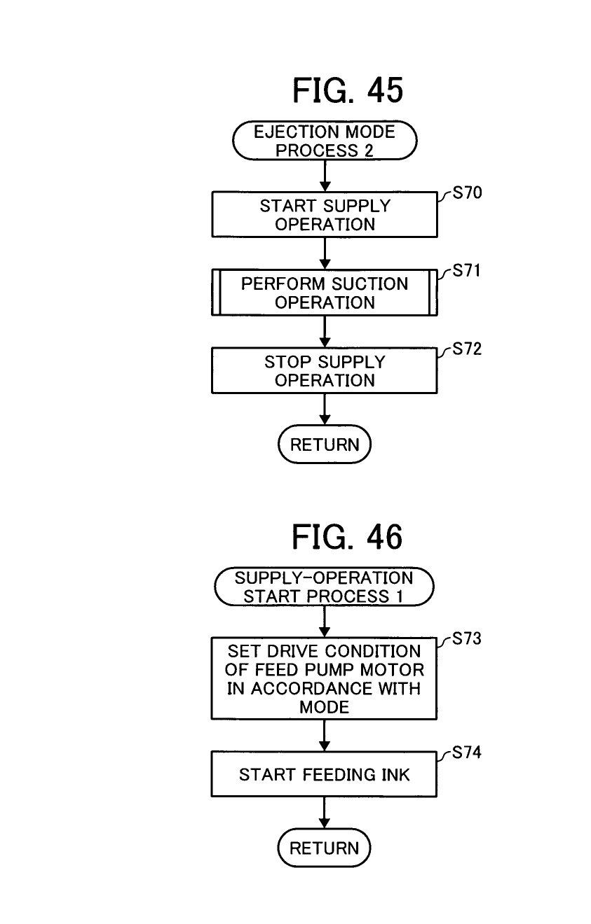

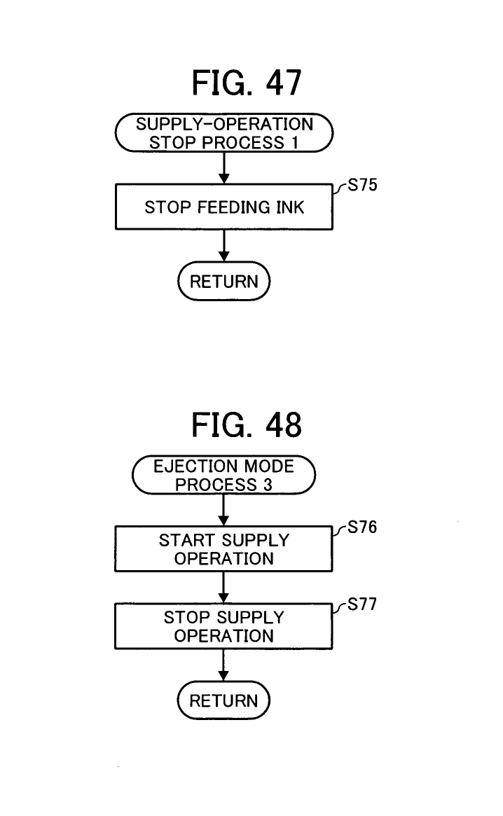

For the fifth exemplary embodiment, in the first ejection mode, the above-described ejection mode process 2 illustrated in FIG. 45 is performed to eject ink from heads 101 by using ink-supply and cap-suction operations together. In the second ejection mode, an ejection mode process 3 illustrated in FIG. 48 is performed to eject ink from heads 101 by using only the ink supply operation.

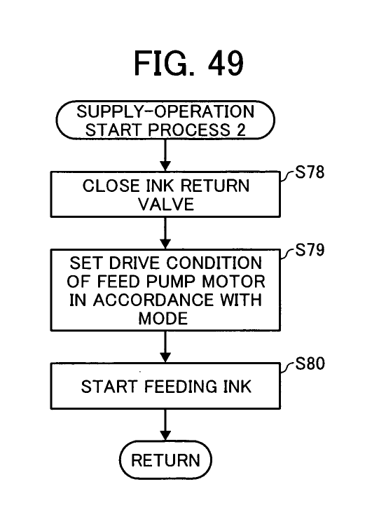

Further, in the first ejection mode, a supply-operation start process 2 illustrated in FIG. 49 is performed as the supply-operation start process in the ejection mode process 2.

In the supply-operation start process 2, at S78, an ink return valve 155 is closed. At S79, the drive condition of a feed pump 153 is set to a setting value for sending a larger amount of ink than an ejection amount of ink during an ink ejection operation. While the ink return valve 155 is closed, at S80, the feed pump 153 is driven to start feeding ink. With the ink feeding, ink is fed from a subsidiary reservoir 14 to the heads 101, thus increasing the internal pressure of the heads.

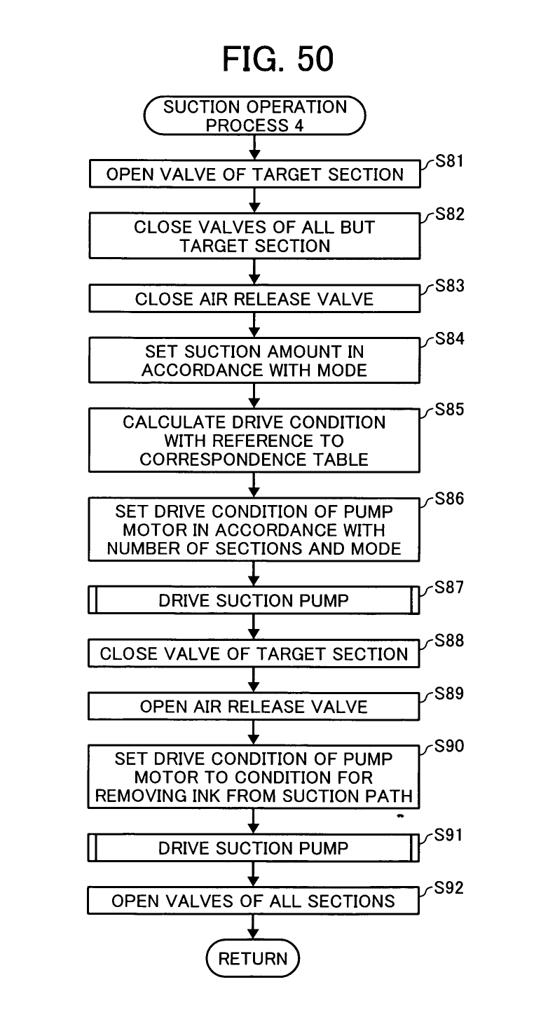

In such a state, a suction operation process 4 illustrated in FIG. 50 is performed to suction ink.

As illustrated in FIG. 50, at S81, a valve 214 of a suction section 211 corresponding to a target head 101 to be suctioned is opened. At S82, all valves 214 except the target valve 214 are closed and at S83 an air release valve 216 is closed.

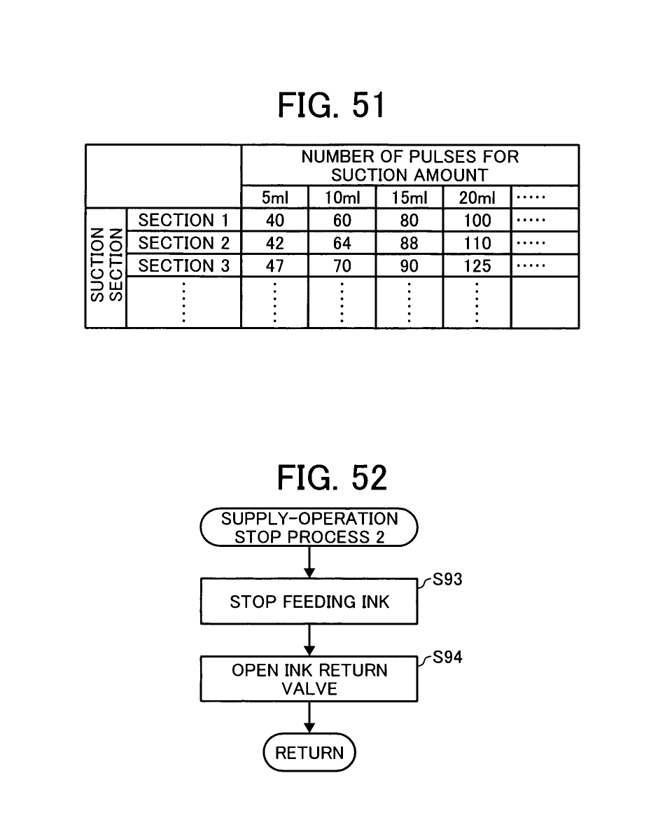

At S84, the suction amount of a suction pump 202 is set in accordance with the ejection amount for the first ejection mode. At S85, the drive condition of a motor to drive the suction pump 202 is calculated with reference to a predefined correspondence table, as illustrated in FIG. 51, between the suction sections and the suction amounts.

At S86, the drive condition of the motor is set in accordance with the number of the suction sections and the ejection mode. At S87, the motor of the suction pump 202 is driven under the drive condition set at S86 to drive the suction pump 202 and thereby suction ink.

Incidentally, the correspondence table contains relation among the suction section, the suction amount, and the number of pulse.

After the ink suction, the process goes to a supply-operation stop process 2 illustrated in FIG. 52. At S93, the suction pump 202 stops feeding ink and at S94 the ink return valve 155 is opened to return excess ink to the subsidiary reservoir 14. Thus, the internal pressure of the heads 101 is returned to atmospheric pressure.

The process goes to S88 of the suction operation process 4. At S88, the target valve 214 is closed and at S89 the air release valve 155 of the cap member 211 is opened so that the suction paths returns to atmospheric pressure.

At S90, the drive condition of the motor of the suction pump 202 is set to a condition for removing ink from the suction paths. At S91, the suction pump 202 is driven to remove ink from the suction paths 212 and 213. At S92, the valves 214 of all suction sections are opened.

On the other hand, in the second ejection mode of the fifth exemplary embodiment, the supply-operation start process 2 illustrated in FIG. 49 is performed. At S78, the ink return valve 155 is closed. At S79, the drive condition of the feed pump 153 is set based on a setting value for the ejection amount of ink. Under the drive condition, at S80, the feed pump 153 is driven to start feeding ink. With the ink feeding, ink is fed from the subsidiary reservoir 14 to the heads 101, thus increasing the internal pressures of the heads 101. When the internal pressure exceeds the surface tensions of ink meniscuses in the nozzles 102, ink flows out from the nozzles 102 of the heads 101.

When the amount of waste liquid defined for the second ejection mode is supplied, the process goes to the supply-operation stop process 1 illustrated in FIG. 52 and at S93 the ink feeding is stopped. At S94, the ink return valve 155 is opened to return excess ink to the subsidiary reservoir 14.

Then, similar to the first ejection mode, the internal pressure of the heads 101 is reduced to atmospheric pressure and the ink suction operation is stopped.

Thus, such ink ejection by pressurizing the insides of the heads can prevent the maintenance operation for the target head from affecting its adjacent heads. Further, the combination of the pressurizing ejection and the suction ejection in the first ejection mode can provide a relatively high recovery performance. The pressurizing ejection can also reduce the power of the suction pump, thereby reducing the size or noise of the image forming apparatus.

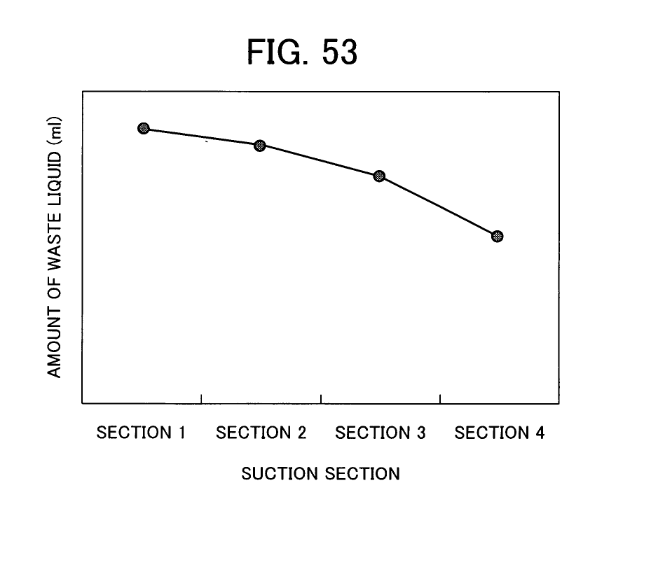

As illustrated in FIG. 53, the amount of waste liquid for the suction amount of the suction pump is different among the heads due to the position of the suction sections or the length and diameter of ink supply path. Hence, the suction amount of the suction pump for each suction section is changed based on a value corresponding to the suction section so that the ejection amount of ink becomes equal between the heads. Thus, a variation in the recovery performance from a discharge failure can be suppressed, thereby enhancing the reliability of the maintenance operation.

In such a case, the value corresponding to each suction section is determined based on a value corresponding to the ejection mode, for example, a value corresponding to an ink ejection amount in the ejection mode. Thus, the ejection amount of ink from the heads can be set to a certain value, suppressing a variation in the recovery performance from a discharge failure so as to enhance the reliability of the maintenance operation.

As described above, in the first ejection mode for the suction operation, both the pressurizing ejection and the suctioning ejection are performed so as to suction a relatively large amount of ink while in the second mode only the pressurizing ejection is performed so as to suction a relatively small amount of ink. Further, one of the ink ejection processes 1 to 7 described with reference to FIGS. 26 to 32 is performed and thus a maintenance failure in the wiping operation can be suppressed.

In such a configuration, in addition to the suction ejection, the pressurizing ejection is performed by increasing the internal pressure of the heads using the feed pump. Thus, a relatively high reliability of the maintenance operation and a relatively high recovery performance can be obtained while reducing the power of the pump.

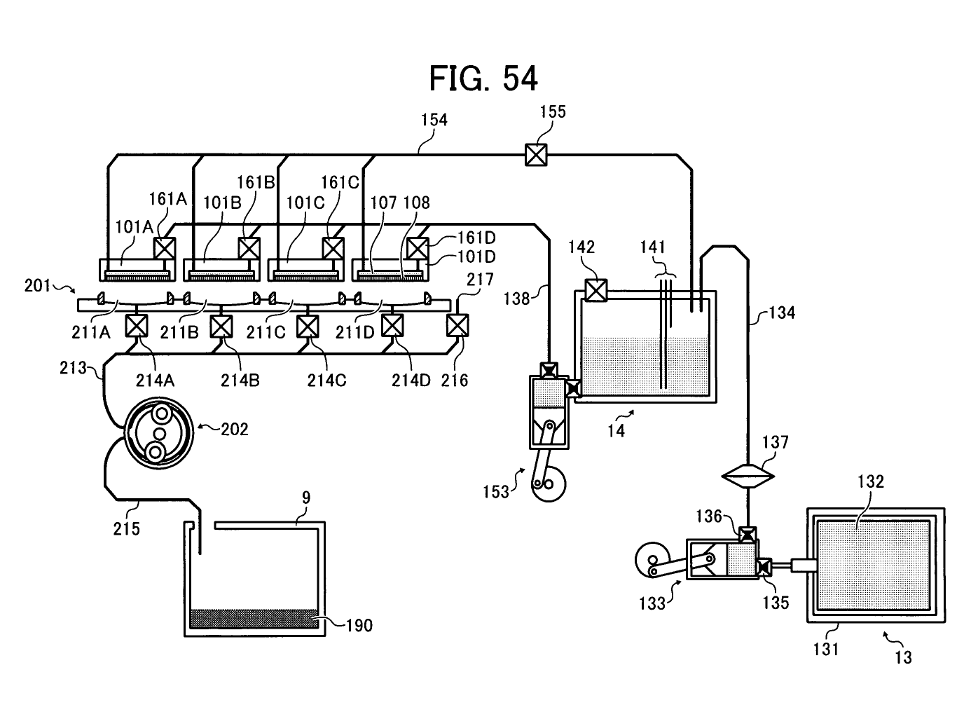

Next, a sixth exemplary embodiment is described with reference to FIG. 54. FIG. 54 is a schematic view of an ink path according to the sixth exemplary embodiment.

As illustrated in FIG. 54, the image forming apparatus is provided with a feed pump 153 to pump ink stored in a subsidiary reservoir 14 toward a head unit 11. The feed pump 153 feeds ink through the ink supply path 138 to the heads 101A to 101D. Head supply valves 161A to 161D to open and close the ink supply path 138 for the respective heads 101A to 101D are disposed between the feed pump 153 and the respective heads 101A to 101D. Further, return channels from the respective heads 101A to 101D are merged into one return channel 154 that is connected to the subsidiary reservoir 14 via an ink return valve 155. Other configuration is substantially identical to that of the first exemplary embodiment and therefore redundant descriptions are omitted for the sake of simplicity.

A maintenance operation in the sixth exemplary embodiment may be identical to any of the maintenance operations 1 to 4 according to the first exemplary embodiment illustrated in FIGS. 22 to 25. In the maintenance operation, an liquid ejection process is performed before a wiping operation. The ink ejection process may be identical to any of the ink ejection processes 1 to 7 illustrated in FIGS. 26 to 32 according to the first exemplary embodiment.

An ejection mode process performed in the ink ejection process may be identical to the ejection mode process 2 illustrated in FIG. 45.

In the ejection mode process 2, at S70, an ink supply operation is started to supply ink to the head 101. At S71, a suction operation through cap members 211 is performed to eject ink from the heads 101 and at S72 the ink supply operation is stopped.

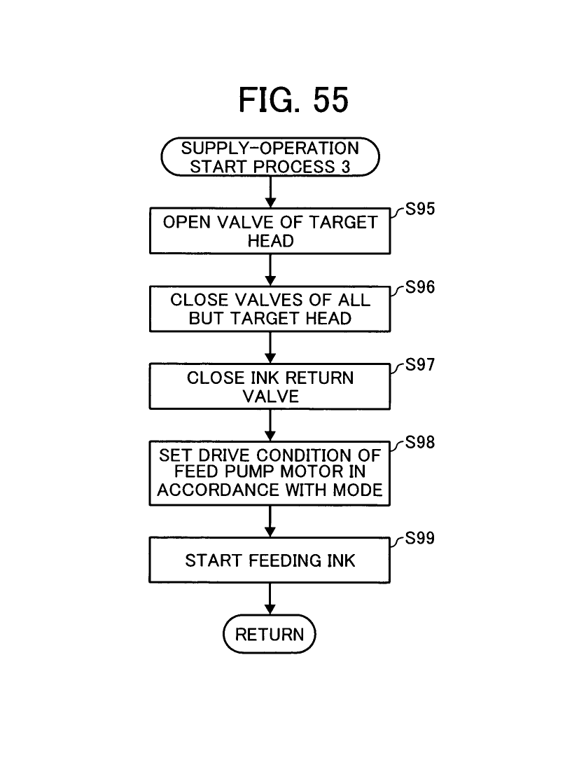

In the suction operation, a supply-operation start process 3 illustrated in FIG. 55 is performed. At S95, a head supply valve 161 for a target head 101 is opened and at S96 head supply valves 161 for all heads except the target head are closed. At S97, the ink return valve 155 is closed and at S98 the drive condition of a motor to drive the feed pump 153 is set to a condition capable of feeding a larger amount of ink than an amount of ink ejected in the ink ejection operation in accordance with the ink ejection mode. At S99, the feed pump 153 is driven to start feeding ink. With the start of ink feeding, ink is fed from the subsidiary reservoir 14 to the heads 101, increasing the internal pressures of the heads 101.

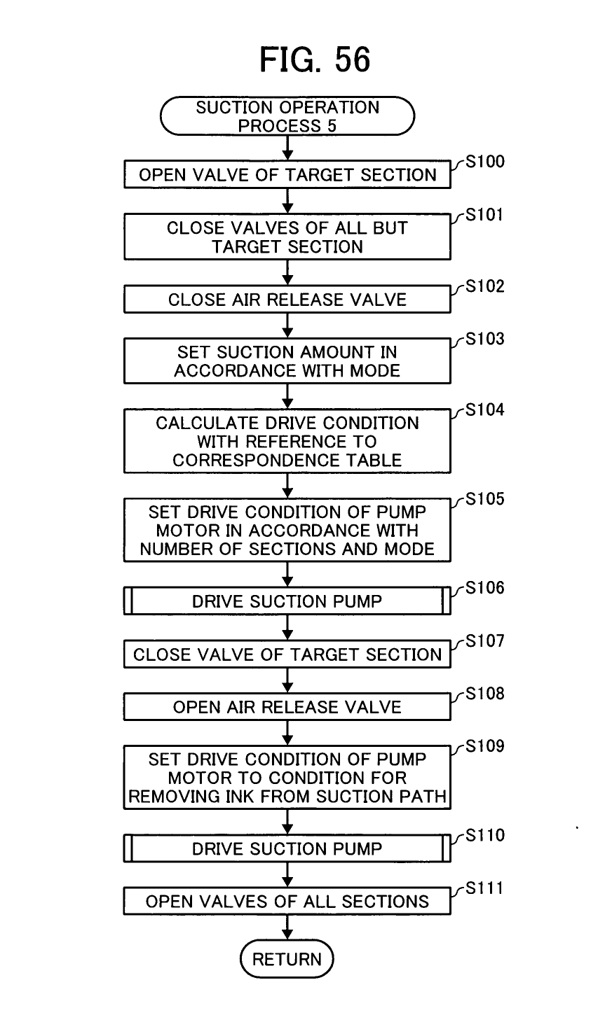

In such a state, a suction operation process 5 illustrated in FIG. 56 is performed to suction the heads 101. At S100, a valve 214 of a suction section 211 for a target head 101 is opened and at S101 valves 214 of all suction sections 211 except the target section 211 are closed. At S102, an air release valve 216 is closed.

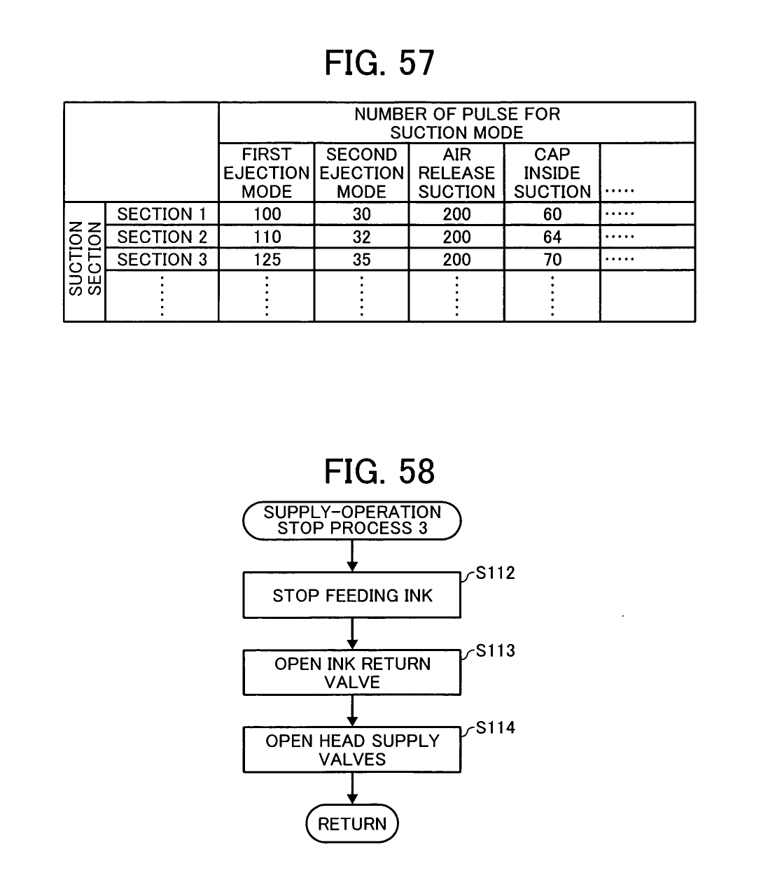

At S103, the suction amount of a suction pump 102 is set based on an ejection amount defined for the ink ejection mode. At S104, the drive condition of the motor to drive the suction pump 202 is calculated with reference to a correspondence table between the suction section and the suction amount as illustrated in FIG. 57. At S105, the drive condition of the motor is set based on the number of the suction sections and the ejection mode. At S106, the motor of the suction pump 202 is driven under the drive condition set at the S105. Thus, the suction pump 102 is driven to suction ink from the heads 101.

Incidentally, the correspondence table contains relationships between the suction section and the number of pulses defined for the first and second ejection modes.

After the ink suction, a supply-operation stop process 3 illustrated in FIG. 58 is performed. At S112, the ink feeding is stopped and at S112 the ink return valve 155 is opened to return excess ink to the subsidiary reservoir 14. Thus, the internal pressure of the heads 101 is reduced to atmospheric pressure. At S114, all heads 161 are closed to stabilize the internal pressure of the heads 101. The process goes to S107.

At the S107, the target valve 214 is closed and at S198 the air release valve 155 on the side of the cap members 211 is opened so that the separate suction paths and the common suction path returns to atmospheric pressure.

At S109, the drive condition of the motor of the suction pump 202 is set to a condition for removing ink from the suction paths. At S110, the suction pump 202 is driven to remove ink from the suction paths. At S111, the valves 214 of all the suction sections 211 are opened.

Such a configuration can suppress a resistance that may be caused in separating the heads from the cap members, thereby preventing an undesirable ink ejection due to a negative pressure that might be otherwise caused. Further, such removal of ink from the suction paths can reduce a variation in suction condition, for example, a variation in pressure between suction operations. When the ejection mode process 5 of FIG. 30 is performed to suction the heads 101 in turn, a variation in suction between the heads can be reduced, resulting in a stable recovery performance from a discharge failure.

Moreover, changing the suction amount of the suction pump for the respective suction sections allows a certain amount of ink to be uniformly ejected from the respective heads 101. Thus, a variation in the recovery performance from a discharge failure can be suppressed, thereby enhancing the reliability of the maintenance operation.

The ink supply system is branched and provided with the ink supply valves 161 corresponding to the respective heads. The ink supply valves 161 control the internal pressures of the heads 101 so that the suction operation for a target head may not generate a negative pressure in an adjacent head. Thus, the suction operation for the target head can be prevented form affecting the adjacent heads, enhancing the reliability of the maintenance operation. As a result, the suction operation with a higher intensity or the pressurizing operation with a higher pressure can be performed.

Further, the pressurizing ejection from the heads and the suction ejection from the side of the cap members may be combined to obtain a high recovery performance, facilitating a reduction of the power of the suction pump. Since the heads can be separately pressurized in this configuration, the pressurizing ejection can also reduce the power of the feed pump. Such reduction in the powers of the pumps may result in a reduction in the size, noise, or consumption power of the image forming apparatus.

The suction operation may be configured so that in the first ejection mode both the pressurizing ejection and the suction ejection is performed to suction a relatively large amount of ink while in the second ejection mode only the pressurizing ejection is performed to suction a relatively small amount of ink. Further, any of the ink ejection processes 1 to 7 described above with reference to FIGS. 26 to 32 may be performed to prevent a maintenance failure in a wiping operation. In such a case, since the heads can be separately pressurized, the suction recovery operation is separately performed on a target head, resulting in a relatively high recovery performance from a discharge failure and a high reliability of the maintenance operation. Moreover, an interaction in pressurizing heads facilitates a reduction in the powers of the feed pump and the suction pump. The pumps are appropriately driven for the respective suction sections, enhancing the stability and reliability of the maintenance operation.

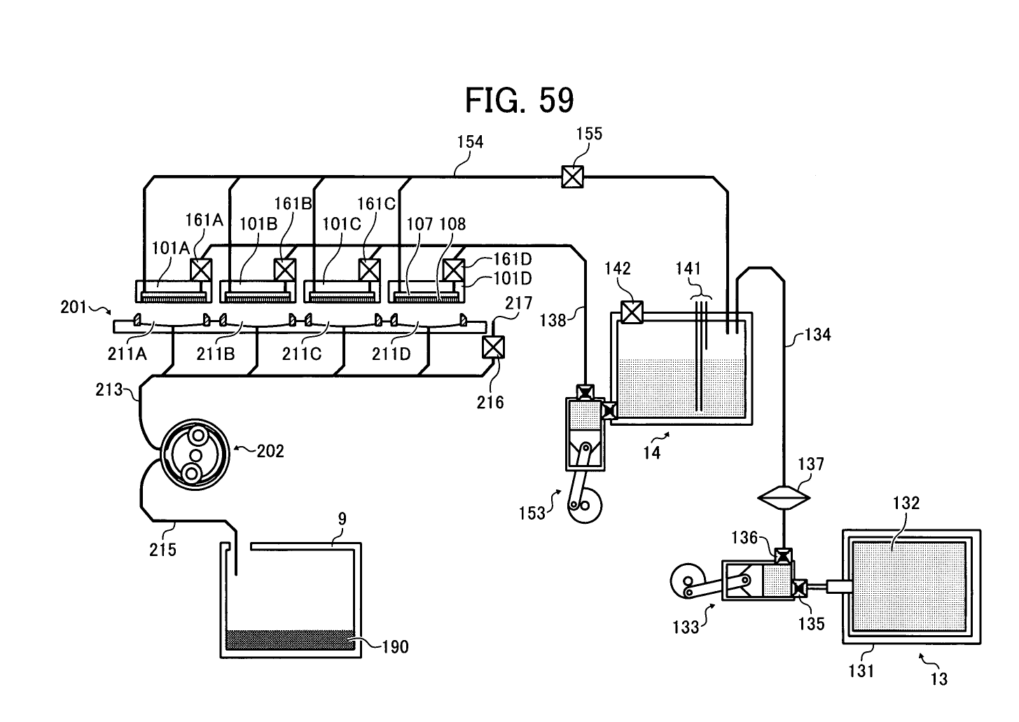

Next, a seventh exemplary embodiment is described with reference to FIG. 59. FIG. 59 is a schematic view illustrating an ink path according to the seventh exemplary embodiment.

In FIG. 59, similar to the sixth exemplary embodiment, a feed pump 153 is provided to pump ink stored in a subsidiary reservoir 14 to a head unit 11. The feed pump 153 feeds ink through an ink supply path 138 to heads 101A to 101D. Head supply valves 161A to 161D to open and close the ink supply path 138 for the respective heads 101A to 101D are disposed between the feed pump 153 and the respective heads 101A to 101D. Further, return channels from the respective heads 101A to 101D are merged into one return channel 154 and communicated to the subsidiary reservoir 14 via an ink return valve 155. However, unlike the sixth exemplary embodiment, the ink path of the seventh exemplary embodiment has no valves 214 of separate suction paths corresponding to the respective suction sections or cap members 211. The other configuration is substantially identical to that of the first exemplary embodiment and therefore redundant descriptions are omitted for the sake of simplicity.

A maintenance operation according to the seventh exemplary embodiment may be identical to any of the maintenance operations 1 to 4 illustrated in FIGS. 22 to 25 according to the first exemplary embodiment. In any of the maintenance operations, the ink ejection process is performed before the wiping operation. The ink ejection process may be identical to any of the ink ejection processes 1 to 7 illustrated in FIGS. 26 to 32 according to the first exemplary embodiment.

An ejection mode process performed in the ink ejection process may be identical to the ejection mode process 2 illustrated in FIG. 45.

In the ejection process 2, at S70, an ink supply operation is started to supply ink to the head 101 and at S71 a suction operation through cap members 211 is performed to eject ink from the heads 101. At S72, a supply-operation stop process is performed to stop the ink supply operation.

In the suction operation at the S71, the supply-operation start process 3 illustrated in FIG. 55 is performed. At S95, a head supply valve 161 for a target head 101 is opened and at S96 head supply valves 161 for all heads except the target head are closed. At S97, the ink return valve 155 is closed and at S98 the drive condition of a motor to drive the feed pump 153 is set to a condition capable of feeding a larger amount of ink than an amount of ink ejected in the ink ejection operation in accordance with the ink ejection mode. At S99, the feed pump 153 is driven to start feeding ink. With the start of ink feeding, ink is fed from the subsidiary reservoir 14 to the heads 101, increasing the internal pressures of the heads 101.

In such a state, the suction operation process 2 illustrated in FIG. 41 is performed to suction the heads 101, although this configuration has only one suction pump 202. At S58, the drive condition of the motor to drive the suction pump 202 is determined based on a setting value obtained from an ejection amount of ink defined for the suction mode. At S59, the motor is driven under the drive condition set at S58 to drive the suction pump 202.

After the suction operation process 2, the supply-operation stop process 3 illustrated in FIG. 58 is performed. At S112, ink feeding is stopped and at S112 an ink return valve 155 is opened. Thus, excess ink is returned to the subsidiary reservoir 14 and the internal pressure of the heads 101 is returned to atmospheric pressure. At S114, all the head supply valves 216 are opened so as to stabilize the internal pressures of the heads 101. When an air release valve 216 is opened, suction paths are returned to atmospheric pressure. Thus, ink remaining in the suction paths is removed and all the valves for the suction sections are opened.

Such a configuration can suppress a resistance that may be caused in separating the heads from the cap members, thereby preventing an undesirable ink ejection due to a negative pressure. Further, such removal of ink from the suction paths can reduce a variation in suction condition, for example, a variation in pressure between suction operations.

Moreover, since all the heads of the head unit are simultaneously suctioned, the forcible ejection of a target head does not affect its adjacent heads in the above-described manner, enhancing the reliability of the maintenance operation.

Alternatively, use of a pressurizing ejection from the heads can facilitate a reduction in the power of the suction pump for suctioning the head unit, resulting in a reduction in the size, noise, or consumption power of the image forming apparatus.

Thus, the suction operation may be configured so that, in the first ejection mode, both the pressurizing ejection and the suction ejection are used to suction a relatively large amount of ink while, in the second ejection mode, only the pressurizing ejection is performed to suction a relatively small amount of ink. Any of the ink ejection processes 1 to 7 described above with reference to FIGS. 26 to 32 may be performed to prevent a maintenance failure in a wiping operation.

In such a case, since the heads are separately pressurized and are simultaneously suctioned, a desirable reliability of the maintenance operation can be obtained with a relatively simple configuration. The use of the pressurizing ejection can reduce the power of the suction pump.

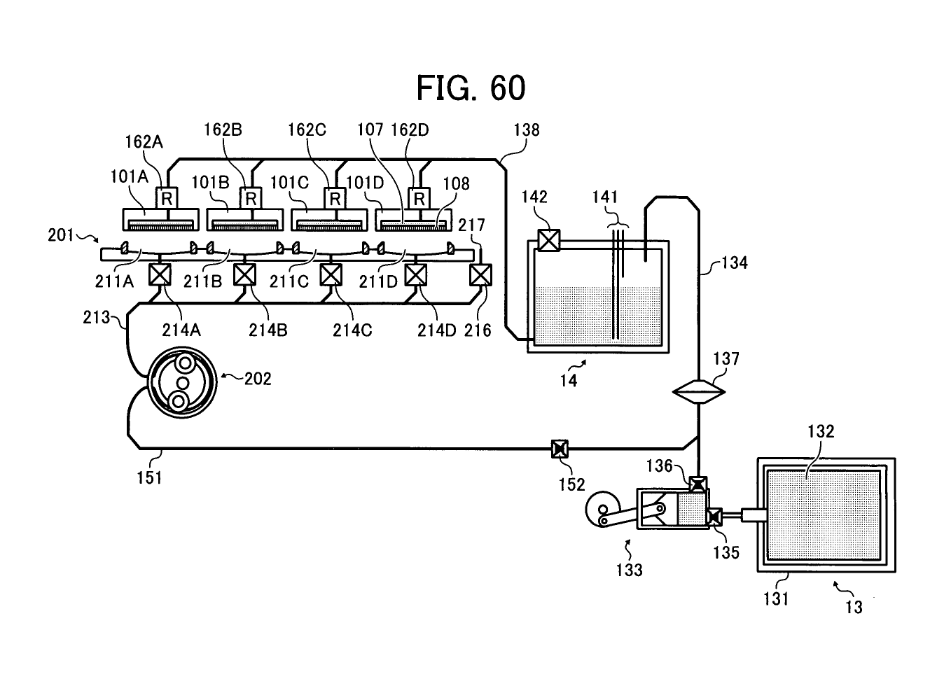

Next, an eighth exemplary embodiment is described with reference to FIG. 60. Incidentally, FIG. 60 is a schematic view illustrating an ink path according to the seventh exemplary embodiment.

In FIG. 60, similar to the third exemplary embodiment described above with reference to FIG. 42, an ejection side of a suction pump 202 is connected via a circular path 151 to a portion between a supply pump 133 and an upstream side of a filter 137 of an ink supply path 134. The circular path 151 is provided with a check valve 152.

An ink supply path 138 connecting the subsidiary reservoir 14 to the heads 101 is provided with resistance portions 162A to 162D corresponding to the heads 101A to 101D, respectively. When a suction section is far from the suction pump 202, the resistance portion of a head corresponding to the suction section is set to have a relatively small supply resistance value. The supply resistance value is set based on the cross section of channel and the length of resistance portion for each head 101.

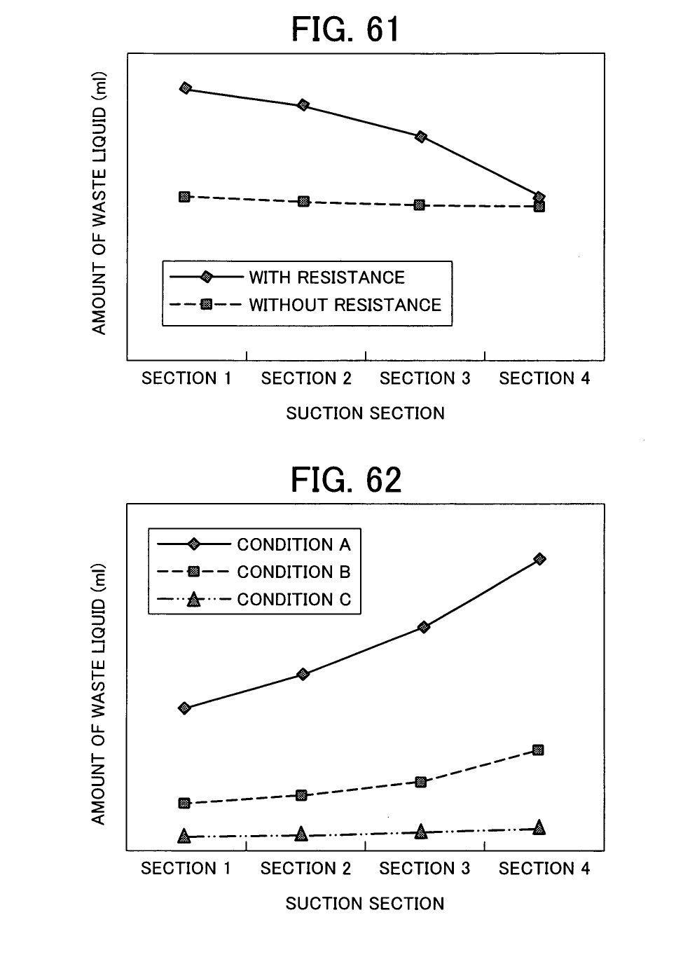

For example, FIG. 61 illustrates an example of the amounts of ink ejected from the respective heads 101 when a certain amount of ink is suctioned by the suction pump 202. As illustrated in full line in FIG. 61, when no supply resistance is added, the farther the farther a head from the suction pump 202, the larger amount of ink is ejected from the head by suctioning because of differences in the position of suction section and the length or diameter of tube. On the other hand, as illustrated in FIG. 61, when an appropriate supply resistance is given to the heads 101, the closer the corresponding suction section of a head to the suction pump 202, the smaller amount of ink is ejected from the head. In this example, the suction section 1 is closest to the suction pump 202 and the suction sections 2, 3, and 4 are further away from the suction pump 202 in this order. As illustrated in dashed line in FIG. 61, such an appropriate supply resistance can equalize the ejection amounts of ink between the suction sections.

Further, in FIG. 62, the condition “A” indicates an average suction pressure in the first ejection mode, the condition “B” an average suction pressure in the second ejection mode, and the condition “C” a suction pressure with which an amount of ink corresponding to a maximum ejection level is ejected.

A maintenance operation in the eighth exemplary embodiment may be any of the maintenance operations 1 to 4 illustrated in FIGS. 22 to 25 according to the first exemplary embodiment. In the maintenance operation, an ink ejection process is performed before a wiping operation. The ink ejection process may be any of the ink ejection processes 1 to 7 illustrated in FIGS. 26 to 32 according to the first exemplary embodiment.

As an ejection mode process in the ink ejection process, the ejection mode process 1 described above with reference to FIG. 33 is performed to eject ink from the heads 101 by a suction operation through the cap members 211. In the suction operation of the heads 101, the suction operation process 3 illustrated in FIG. 43 is performed. At S60, a valve 214 of a suction section corresponding to a target head 101 is opened. At S61, the valves 214 of the other suction sections except the target section are closed and at S62 an air release valve 216 is closed.

At S63, the drive condition of a motor to drive the suction pump 202 is set based on a setting value obtained from a suction amount defined for the suction mode. At S64, the suction pump 202 is driven under the drive condition to suction ink.

At S65, the valve 214 of the suction section corresponding to the target head 101 is closed. At S66, the air release valve 216 of the common suction path 213 is opened to return a suction path to atmospheric pressure.

At S67, the drive condition of the motor of the suction pump 202 is set to a condition for removing ink from the suction path. At S68, under the drive condition set at the S67, the motor is driven so as to drive the suction pump. At S69, the valves 214 of all the sections are opened.

Such a configuration can suppress a resistance that may be generated in separating the cap members 211 from the heads 101, thereby preventing an unintentional ink ejection due to a negative pressure that might be generated in the separating. Further, when an ink ejection process as illustrated in FIG. 30 is performed to suction the heads 101 in turn, a variation in suction between the heads can be suppressed, thereby stabilizing the recovery performance from a discharge failure.

Thus, the suction operation may be configured so that, in the first ejection mode, both a pressurizing ejection and the suction ejection is performed to suction a relatively large amount of ink while, in the second ejection mode, only the pressurizing ejection is perform to suction a relatively small amount of ink. Any of the ink ejection processes 1 to 7 described above with reference to FIGS. 26 to 32 may be performed to prevent a maintenance failure in a wiping operation. In such a case, in addition to advantages of the third exemplary embodiment, the suction ejection amounts can be equalized between the heads 101, reducing a variation in the recovery performance. Further, an appropriate suction condition can be set so as to reduce the total waste amount of ink.

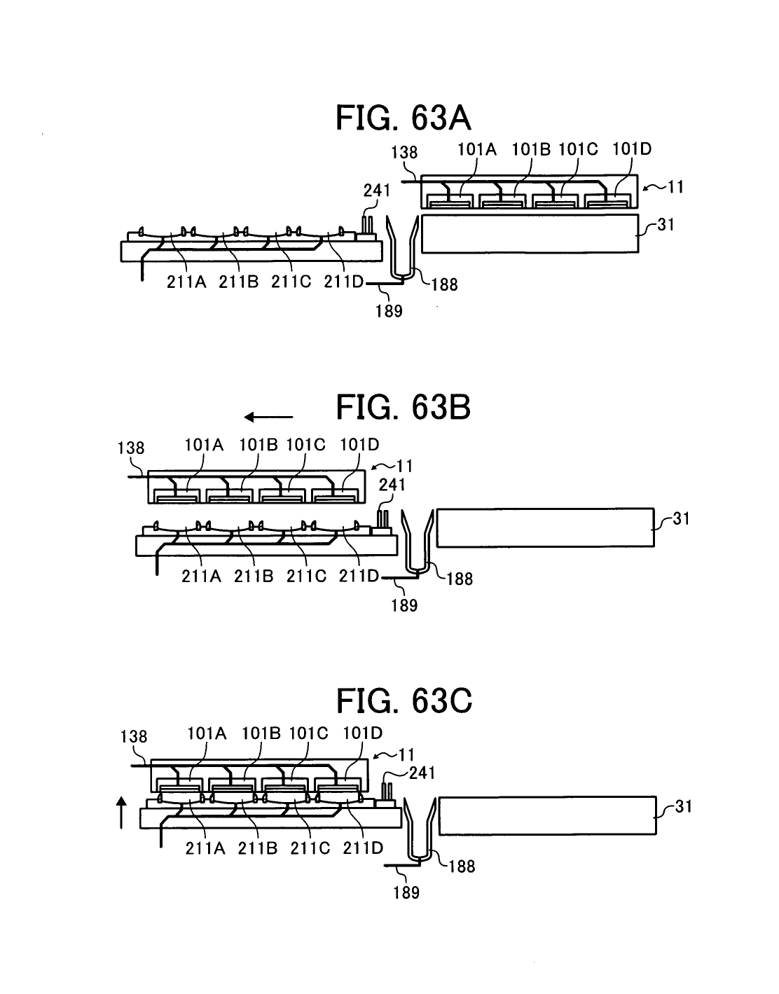

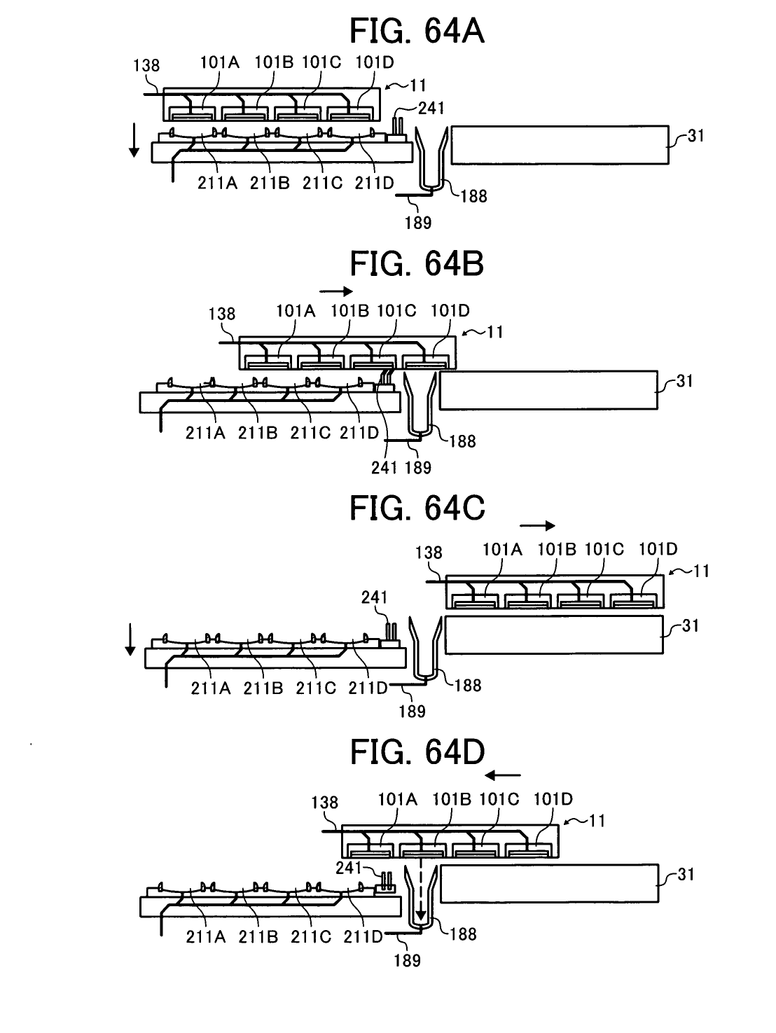

Next, a ninth exemplary embodiment is described with reference to FIGS. 63A to 63C and 64A to 64C. FIGS. 63 and 64 illustrate operations of a head unit and a maintenance unit. Members and components corresponding to those of the above-described exemplary embodiments are attached to reference numbers identical thereto.

In the ninth exemplary embodiment, a maintenance unit 12 is disposed next to a sheet conveyance path. A head unit 11 and the maintenance unit 12 are both movable.

In a maintenance operation in the ninth exemplary embodiment, the head unit 11 and the maintenance unit 12 are in printing states as illustrated in FIG. 63A. As illustrated in FIG. 63B, the head unit 11 is moved and stopped above the maintenance unit 12. As illustrated in FIG. 60C, the maintenance unit 12 moves upward to such a position that the cap members 211 closely contact the nozzle faces of the heads of the head unit 11 and stops in a capping state.

While the nozzle faces are capped with the cap members 211, the ink ejection process and the wiping operation are performed. In the wiping operation, as illustrated in FIG. 64C, the maintenance unit 12 moves downward and stops at a wiping position lower than the top faces of wiper members 241 by approximately 0.2 to 0.5 mm. As illustrated in FIG. 64B, the head unit 11 moves in a horizontal direction to wipe the nozzle faces of the heads 101 of the head unit 11. As illustrated in FIG. 64C, the head unit 11 moves to the printing position and the maintenance unit 12 moves downward and stops. From such a state, as illustrated in FIG. 64D, when moving to a position directly above the maintenance unit 12, the head unit 11 sequentially performs preliminary discharge operations from the nozzles of the respective heads 101 to a waste ink receiver 188. The head unit 11 moves to the printing position and returns to the printing state illustrated in FIG. 63A.

The maintenance operations described above in the first to eighth exemplary embodiments can be also performed in such a configuration and similar effects to those described above can be obtained.

Numerous additional modifications and variations are possible in light of the above teachings. It is therefore to be understood that, within the scope of the appended claims, the disclosure of this application may be practiced otherwise than as specifically described herein.

Further, elements and/or features of different exemplary embodiments and/or examples may be combined with each other and/or substituted for each other within the scope of this disclosure and appended claims.

The present disclosure claims priority under 35 U.S.C. §119 from Japanese Patent Application No. 2007-015893, filed on Jan. 26, 2007 in the Japan Patent Office, the entire contents of which are hereby incorporated herein by reference.

What is claimed is:

1. An image forming apparatus comprising:
a head unit including a plurality of liquid discharge heads configured to discharge liquid droplets, each liquid discharge head having a nozzle face on which a plurality of nozzles are formed;
a cap unit configured to cap the nozzle faces of the liquid discharge heads;
a suction device configured to suction an inside of the cap unit while the nozzle faces of the liquid discharge heads are capped with the cap unit;
a wiper unit configured to wipe the nozzle faces of the liquid discharge heads, nozzle faces of different liquid discharge heads thereof partially overlapping with each other, a first portion of a first nozzle face of one liquid discharge head of the different liquid discharge heads being wiped after a second portion of a second nozzle face of another liquid discharge head of the different liquid discharge heads which is partially overlapped with the first portion is wiped by the wiper unit; and
a control unit configured to control maintenance operation of the liquid discharge heads by selecting a first ejection operation and a second ejection operation, wherein the control unit controls the first ejection operation to eject a first amount of liquid from a first liquid discharge head having a discharge failed nozzle among the plurality of liquid discharge heads, and controls the second ejection operation to eject a second amount of liquid, which is less than the first amount, from a second liquid discharge head having no discharge failed nozzle among the plurality of liquid discharge heads.

2. The image forming apparatus according to claim 1, wherein, in addition to the first ejection operation, the second ejection operation is performed on the first liquid discharge head having the discharge failed nozzle.

3. The image forming apparatus according to claim 1, wherein the second ejection operation is performed from the liquid discharge head having no discharge failed nozzle.

4. The image forming apparatus according to claim 1, wherein the image forming apparatus includes a plurality of head units similarly constituted as said head unit, and the maintenance operation including the first ejection operation is performed for one of the plurality of head units, having a liquid discharge head with a discharge failed nozzle.

5. The image forming apparatus according to claim 1, wherein the cap unit has suction sections partitioned for the respective liquid discharge heads.

6. The image forming apparatus according to claim 5, wherein the suction device separately suctions the suction sections of the cap unit.

7. The image forming apparatus according to claim 6, further comprising valves disposed between the suction device and the respective suction sections.

8. The image forming apparatus according to claim 6, wherein the image forming apparatus includes a plurality of suction devices similarly constituted as said suction device, so that each of the plurality of suction sections of the cap unit is suctioned with a corresponding one of the plurality of suction devices.

9. The image forming apparatus according to claim 6, wherein a suction amount of the suction device is variably determined based on values defined for the respective suction sections of the cap unit.

10. The image forming apparatus according to claim 9, wherein the suction amount of the suction device for the respective suction sections of the cap unit is set to different amounts in the first ejection operation and the second ejection operation, respectively.

11. The image forming apparatus according to claim 9, wherein the suction amount of the suction device for the suction sections of the cap unit is set to values corresponding to liquid ejection amounts of the respective suction sections.

12. The image forming apparatus according to claim 6, further comprising a liquid supply path to supply liquid to the liquid discharge heads, wherein the liquid supply path has different fluid resistances corresponding to liquid capacities between the suction device and the respective suction sections.

13. The image forming apparatus according to claim 1, wherein the head unit has a head support member to support the liquid discharge heads, the head support member being disposed on a plane identical to the nozzle faces of the liquid discharge heads, and wherein a clearance between the head support member and each of the liquid discharge heads is filled with resin.

14. The image forming apparatus according to claim 1, the head unit has a recording area corresponding to a width of a recording medium.
